(19) United States
(12) Patent Application Publication
(10) Pub. No.: US 2026/0062612 A1
(43) Pub. Date: Mar. 5, 2026

(54) OXIDE PHOSPHOR AND LIGHT-EMITTING DEVICE

(71) Applicant: NICHIA CORPORATION, Anan-shi (JP)

(72) Inventor: Yoshinori MURAZAKI, Komatsushima-shi (JP)

(73) Assignee: NICHIA CORPORATION, Anan-shi (JP)

(21) Appl. No.: 19/315,479

(22) Filed: Aug. 29, 2025

(30) Foreign Application Priority Data
Aug. 30, 2024 (JP) 2024-148286

(51) Int. Cl. C09K 11/62

(52) U.S. Cl. CPC C09K 11/62

(57) ABSTRACT

An oxide phosphor has a composition represented by Formula (1) below: (Li₁₋ₛM¹ₛ)(Mg₁₋ₜM²ₜ)ᵤ(Ga₁₋ᵥM³ᵥ)_{w}Oₓ:Cr_{y},M⁴_{z} (1), wherein in Formula (1), M¹ is at least one element selected from the group consisting of Na, K, Rb, and Cs; M² is at least one element selected from the group consisting of Ca, Sr, Ba, and Zn; M³ is at least one element selected from the group consisting of Al and Sc; M⁴ is at least one element selected from the group consisting of Ni, Ce, Eu, Fe, Mn, Nd, Tm, Ho, Er, and Yb; s, t, u, v, w, and x satisfy 0≤s≤0.5, 0≤t≤1.0, 0.03≤u≤10, 0≤v≤1.0, 5.1≤w≤25, 0.005≤u/w≤0.4, and 8.2≤x≤48; and when Li is taken as 1 or a total of Li and M¹ is taken as 1, y and z satisfy 0.02≤y≤0.5, 0≤z≤0.3, and y>z with respect to Li or to the total of Li and M¹, respectively.

### CROSS-REFERENCE TO RELATED APPLICATION

This application claims priority to Japanese Patent Application No. 2024-148286 filed on Aug. 30, 2024, the disclosure of which is hereby incorporated by reference in its entirety.

### BACKGROUND

### Technical Field

The present disclosure relates to an oxide phosphor and a light-emitting device.

### Background Art

Light-emitting devices having emission intensities in a red to near-infrared wavelength range are demanded to be used in, for example, light sources for plant growth and cultivation. The light-emitting devices having emission intensities in the red to near-infrared wavelength range are demanded to be used in, for example, in addition to the usage described above, infrared cameras, infrared communications, vein authentication, which is a type of biometric authentication, and food component analysis instruments for non-destructively measuring the sugar content of food products such as fruits and vegetables. There has also been a demand for light-emitting devices that emit light in a wavelength range of visible light as well as in the red to near-infrared wavelength range.

An example of such a light-emitting device is a light-emitting device in which a light-emitting diode (LED) and a phosphor are combined.

Japanese Patent Publication No. 2020-528486 discloses a phosphor that can also be used in the light-emitting device described above, the phosphor having a light emission peak wavelength in a wavelength range of 680 nm to 760 nm and a composition represented by CaYAlO₄:Mn⁴⁺. As a phosphor suitable for each application as described above, for example, there may be a case in which a phosphor that emits red light to near-infrared light with a higher emission intensity is required.

### SUMMARY

An object of the present disclosure is to provide an oxide phosphor emitting light having a light emission peak wavelength in a red to near-infrared wavelength range upon irradiation with excitation light and a light-emitting device including the oxide phosphor.

A first aspect is an oxide phosphor having a composition represented by Formula (1) below:

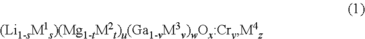

wherein in Formula (1), M is at least one element selected from the group consisting of Na, K, Rb, and Cs; M² is at least one element selected from the group consisting of Ca, Sr, Ba, and Zn; M³ is at least one element selected from the group consisting of Al and Sc; M⁴ is at least one element selected from the group consisting of Ni, Ce, Eu, Fe, Mn, Nd, Tm, Ho, Er, and Yb; s, t, u, v, w, and x satisfy 0≤s≤0.5, 0≤t≤1.0, 0.03≤u≤10, 0≤v≤1.0, 5.1≤w≤25, 0.005≤u/w≤0.4, and 8.2≤x≤48; and when Li is taken as 1 or a total of Li and M¹ is taken as 1, y and z satisfy 0.02≤y≤0.5, 0≤z≤0.3, and y>z with respect to Li or to the total of Li and M¹, respectively.

A second aspect is a light-emitting device including the oxide phosphor and a light-emitting element configured to emit light that has a light emission peak wavelength in a range of 365 nm to 650 nm and to irradiate the oxide phosphor with the light.

According to an aspect of the present disclosure, an oxide phosphor emitting light having a light emission peak wavelength in a red to near-infrared wavelength range of 700 nm to 1500 nm upon irradiation with excitation light and a light-emitting device including the oxide phosphor can be provided.

### BRIEF DESCRIPTION OF DRAWINGS

FIG. 1 is a schematic cross-sectional view illustrating one example of a first configurational example of a light-emitting device.

FIG. 2 is a schematic cross-sectional view illustrating another example of the first configurational example of the light-emitting device.

FIG. 3 is a schematic plan view illustrating a second configurational example of a light-emitting device.

FIG. 4 is a schematic cross-sectional view illustrating the second configurational example of the light-emitting device.

FIG. 5 is a graph illustrating emission spectra of oxide phosphors according to Examples 1 and 2, and emission spectra of oxide phosphors according to Comparative Examples 1 and 2.

FIG. 6 is a graph illustrating emission spectra of oxide phosphors according to Examples 3 and 4.

FIG. 7 is a graph illustrating emission spectra of oxide phosphors according to Examples 5 and 6.

FIG. 8 is a graph illustrating emission spectra of oxide phosphors according to Examples 7 and 8.

FIG. 9 is a graph illustrating an emission spectrum of an oxide phosphor according to Example 9.

FIG. 10 is a graph illustrating emission spectra of oxide phosphors according to Examples 10 and 11.

FIG. 11 is a graph illustrating emission spectra of oxide phosphors according to Examples 12 and 13.

FIG. 12 is a graph illustrating emission spectra of oxide phosphors according to Examples 14 and 15.

FIG. 13 is a graph illustrating emission spectra of oxide phosphors according to Examples 16 to 18.

FIG. 14 is a graph illustrating emission spectra of oxide phosphors according to Examples 19 and 20.

FIG. 15 is a graph illustrating emission spectra of oxide phosphors according to Examples 21 to 23, and emission spectra of oxide phosphors according to Comparative Examples 1 and 3.

FIG. 16 is a graph illustrating emission spectra of oxide phosphors according to Examples 24 to 26.

FIG. 17 is a graph illustrating emission spectra of oxide phosphors according to Examples 27 to 29.

FIG. 18 is a graph illustrating emission spectra of oxide phosphors according to Examples 30 to 32.

FIG. 19 is a graph illustrating an emission spectrum of an oxide phosphor according to Example 33.

FIG. 20 is a graph illustrating emission spectra of oxide phosphors according to Examples 34 and 35.

FIG. 21 is a graph illustrating emission spectra of oxide phosphors according to Examples 36 and 37.

### DETAILED DESCRIPTION

Hereinafter, an oxide phosphor and a light-emitting device according to the present disclosure will be described. The embodiments illustrated below are examples for embodying a technical idea of the present disclosure, and the present disclosure is not limited to the following oxide phosphor, light-emitting device, and method for producing the oxide phosphor. With regard to visible light, the relationship between the color name and the chromaticity coordinates, the relationship between the wavelength range of light and the color name of monochromatic light, and the like conform to JIS Z 8110 standard.

Alight-emitting device including a phosphor is required to emit light in an optimum wavelength range depending on the object to be viewed and the usage conditions. For example, in medical settings and the like, easily obtaining in vivo information may be required. A living body contains light absorbers such as, for example, water, hemoglobin, and melanin. For example, hemoglobin has a high absorption rate of light in a wavelength range of visible light of less than 650 nm, but with a light-emitting device that emits light in a wavelength range of visible light, light in the wavelength range of visible light does not easily penetrate into a living body, and thus in vivo information is not easily obtained. If light within a wavelength range in which absorption and scattering of light in a biological tissue are reduced can be irradiated, information from deeper regions in a living body can be more easily obtained. Therefore, there is a demand for a light-emitting device that can emit light in a wavelength range called a “biological window” in which the light can easily pass through a living body. As the “biological window”, a wavelength range of 650 nm to around 950 nm may be referred to as a “first biological window”, a wavelength range of around 1000 nm to around 1350 nm may be referred to as a “second biological window”, and a wavelength range of around 1500 nm to around 1800 nm may be referred to as a “third biological window”. If light within a wavelength range in which absorption and scattering of light by a tissue in a living body are reduced can be irradiated, information from deeper regions in a living body can be more easily obtained. For example, if an increase or decrease in the concentration of oxygen in blood in a living body can be measured in association with an increase or decrease in the absorption of light by hemoglobin that binds to oxygen, in vivo information can be easily obtained by irradiating with light from the light-emitting device. Further, if the information in deeper regions in a living body is obtained by the irradiation with light of a phosphor and a light-emitting element instead of the irradiation with the X-rays or the like, in vivo information can be obtained more safely. Therefore, the phosphor used in the light-emitting device may be required to have a light emission peak wavelength in a red to near-infrared wavelength range. In some cases, as the phosphor used in the light-emitting device, a phosphor that emits light having a light emission peak wavelength in a range of 680 nm to 1500 nm, preferably from 700 nm to 1500 nm, or 700 nm to 1400 nm when excited by excitation light from the light-emitting element that emits light having a light emission peak wavelength in a range of 365 nm to 650 nm is required. Recently, there has been a demand for a light-emitting device that emits light in a red to near-infrared wavelength range, which can more clearly visualize deeper regions in a living body and has high safety. In the light-emitting device including the light-emitting element and the phosphor, when the phosphor has a high emission intensity and can emit high output light is provided, the detection performance can be further enhanced, and in vivo information can be easily obtained.

In the fields of agriculture and food products, there is a demand for non-destructive sugar content meters that can measure the sugar content of agricultural products and fruits and vegetables without causing damage, and measuring instruments that can non-destructively perform taste tests of foods such as rice (for example, a taste meter (registered trademark)). Near-infrared spectroscopy is sometimes used as a method for non-destructively measuring the internal quality, such as sugar content, acidity, ripeness, or internal damage, of fruits and vegetables, and surface layer quality such as abnormal dryness appearing on the peel surface or peel surface layer near the peel surface of fruits and vegetables. In near-infrared spectroscopy, a fruit or vegetable is irradiated with light in a near-infrared wavelength range, light transmitted through the fruit or vegetable or light reflected by the fruit or vegetable is received, and the quality of the fruit or vegetable is measured by a decrease in the intensity of light (absorption of light). Alight source such as a tungsten lamp or a xenon lamp is used in a near-infrared spectroscopy-based analyzer used in such food product fields. The general rules for near-infrared spectroscopy analysis in JIS K0134 standard state that near-infrared light refers to light in a wavelength range of 700 nm to 2500 nm.

In the midst of environmental changes such as climate change, the ability to stably supply plants such as vegetables and to increase the production efficiency of the plants is desired. Plant factories that can be artificially managed can stably supply safe vegetables to the market, and are anticipated as a next-generation industry. In such a plant factory, a demand exists for a light-emitting device that emits light which can promote plant growth. The reactions of plants in response to light can be divided into photosynthesis and photomorphogenesis. Photosynthesis is a reaction in which water is decomposed using light energy, oxygen is generated, and carbon dioxide is fixed to an organic substance, and is a reaction required for plant growth. Photomorphogenesis is a morphological reaction in which light is used as a signal to conduct seed germination, differentiation (germination formation, leaf formation, or the like), movement (stomatal opening/closing, chloroplast movement), light refraction, and the like. It has been known that in photomorphogenesis reactions, light in a wavelength range of 690 nm to 800 nm affects the photoreceptors of plants. Therefore, a light-emitting device used in a plant factory or the like may be required to have a configuration that can emit light in a wavelength range that affects the photoreceptors (chlorophyll a, chlorophyll b, carotenoid, phytochrome, cryptochrome, and phototropin) of plants and promotes plant growth.

The near-infrared light-emitting phosphor described above is required to be a phosphor having a high emission intensity so that a light-emitting device can emit light suitable for the intended application and allows for performing more precise detection when a light-emitting element such as a light-emitting diode (LED) or a laser diode (LD) that emits violet to blue light is used as an excitation light source of the light-emitting device.

In some cases, a light-emitting device that emits light in a wavelength range of 365 nm or more and less than 700 nm may be required together with light emission in a red to near-infrared wavelength range. For example, in some cases, light emission in a wavelength range of visible light may be required not only to obtain the internal information of a living body or a fruit or vegetable but also to enhance the visibility of an object.

The oxide phosphor has a composition represented by Formula (1) below.

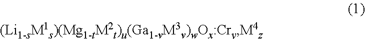

(In Formula (1), M¹ is at least one element selected from the group consisting of Na, K, Rb, and Cs; M² is at least one element selected from the group consisting of Ca, Sr, Ba, and Zn; M³ is at least one element selected from the group consisting of Al and Sc; M⁴ is at least one element selected from the group consisting of Ni, Ce, Eu, Fe, Mn, Nd, Tm, Ho, Er, and Yb; s, t, u, v, w, and x satisfy 0≤s≤0.5, 0≤t≤1.0, 0.03≤u≤10, 0≤v≤1.0, 5.1≤w≤25, 0.005≤u/w≤0.4, and 8.2≤x≤48; and when Li is taken as 1 or a total of Li and M¹ is taken as 1, y and z satisfy 0.02≤y≤0.5, 0≤z≤0.3, and y>z with respect to Li or to the total of Li and M¹.)

The oxide phosphor includes a composition in which an oxide phosphor having a composition represented by Formula (1a) below and an oxide phosphor having a composition represented by Formula (1b) below are combined such that the composition represented by Formula (1b) below is in a range of 0.03 mol to 10 mol when the oxide phosphor having the composition represented by Formula (1a) is taken as 1 mol.

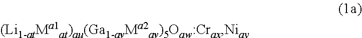

In Formula (1a), M^{a1} is at least one element selected from the group consisting of Na, K, Rb, and Cs; M^{a2} is at least one element selected from the group consisting of Al and Sc; and at, au, av, aw, ax, and ay satisfy 0≤at≤1.0, 0.7≤au≤1.6, 0≤av≤1.0, 7.85≤aw≤11.5, 0.05≤ax≤1.2, 0≤ay≤0.5, 0.25<ax+ay≤1.2, and ax>ay.

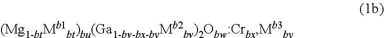

In Formula (1b), M^{b1} is at least one element selected from the group consisting of Ca, Sr, Ba, and Zn; M^{b2} is at least one element selected from the group consisting of Al and Sc; M^{b3} is at least one element selected from the group consisting of Ce, Eu, Mn, Nd, Tm, Ho, Er, and Yb; and bt, bu, by, bw, bx, and by satisfy 0≤bt≤1.0, 0.7≤bu≤1.3, 0≤by ≤0.8, 3.7≤bw≤4.3, 0.02≤bx≤0.3, 0≤by ≤0.2, and bx>by.

In the present specification, the term “molar ratio” refers to the proportion of each element in 1 mol of the chemical composition of the phosphor, unless otherwise specified. In the present specification, a plurality of elements separated by commas (,) in a compositional formula means that at least one element among the elements is contained in the composition. In the present specification, in a compositional formula representing the composition of a phosphor, information preceding the colon (:) represents elements constituting a host crystal and the molar ratio thereof, and information following the colon (:) represents an activating element.

The oxide phosphor having the composition represented by Formula (1a) and the oxide phosphor represented by Formula (1b) have the same cubic crystal structure and have different space groups. The oxide phosphor having the composition represented by Formula (1a) has a cubic crystal structure, and the space group is P4₁32, P4₃32 (space group 213 or 212 of International Tables for Crystallography). The oxide phosphor having the composition represented by Formula (1b) has a cubic crystal structure, and the space group is Fd3m (space group 227 of International Tables for Crystallography). “Fd3m” may also be written with the symbol “-” above the numeral 3, as described below.

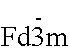

The oxide phosphor having the composition represented by Formula (1) has the composition in which the oxide phosphor having the composition represented by Formula (1b) below in a range from 0.03 mol to 10 mol is combined with respect to 1 mol of the oxide phosphor having the composition represented by Formula (1a), and emits light with a higher emission intensity upon irradiation with excitation light. It is presumed that the oxide phosphor having the composition represented by Formula (1), in which the oxide phosphor having the composition represented by Formula (1a) and the oxide phosphor having the composition represented by Formula (1b) in a range of 0.03 mol to 10 mol per 1 mol of the oxide phosphor having the composition represented by Formula (1a) are combined together, emits light with a higher emission intensity because the lattice lengths in the crystal structure of the oxide phosphor differ between the Mg side and the Li side in the composition of the oxide phosphor, the coordination length around Cr, which is an activating element, changes, and Cr, which is an activating element, is appropriately present in the crystal structure, thus allowing emission of the light with a higher emission intensity. Also, it is presumed that the compound serving as the raw material of Li contained in the composition represented by Formula (1a) and the compound serving as the raw material of Mg contained in the composition represented by Formula (1b) have different melting points, and when the raw materials are mixed to produce the oxide phosphor represented by the formula (1), the compound having a low melting point exerts an effect as a flux on the compound having a high melting point to promote the growth of particles of the oxide phosphor. The oxide phosphor having the composition represented by Formula (1) preferably has a composition in which the oxide phosphor having the composition represented by the Formula (1b) is combined in a range of 0.03 mol to 5 mol, more preferably in a range of 0.05 mol to 4.5 mol, optionally 0.1 mol or more, or 0.2 mol or more with respect to 1 mol of the oxide phosphor having the composition represented by Formula (1a).

In Formula (1), the oxide phosphor having the composition represented by Formula (1) contains Cr, which is an activating element. The oxide phosphor, in Formula (1), has a variable y representing the molar ratio of Cr as an activating element, which satisfies a range of 0.02 to 0.5 (0.02≤y≤0.5), preferably satisfies a range of 0.03 to 0.48 (0.03≤y≤0.48), more preferably satisfies a range of 0.05 to 0.47 (0.05≤y≤0.47), and even more preferably satisfies a range of 0.1 to 0.46 (0.1≤y≤0.46) when Li is taken as 1 or a total of Li and M¹ is taken as 1, with respect to Li or the total of Li and M¹. When the variable y, which represents the molar ratio of Cr as an activating element in Formula (1), satisfies a range of 0.02 to 0.5 (0.02≤y≤0.5), the oxide phosphor can emit light with a higher emission intensity in a red to near-infrared wavelength range upon irradiation with excitation light.

The oxide phosphor having the composition represented by the Formula (1) preferably emits light having a light emission peak wavelength in a range of 700 nm to 1500 nm in the emission spectrum of the oxide phosphor upon irradiation with excitation light, more preferably emits light having a light emission peak wavelength in a range of 705 nm to 1400 nm, even more preferably emits light having a light emission peak wavelength in a range of 710 nm to 1300 nm, and particularly preferably emits light having a light emission peak wavelength in a range of 720 nm to 1250 nm. When the oxide phosphor emits light having a light emission peak wavelength in a range of 700 nm to 1500 nm in the emission spectrum upon irradiation with excitation light, the oxide phosphor can be used in a light-emitting device for obtaining in vivo information, a light-emitting device for non-destructively obtaining information on agricultural products, fruits and vegetables, and the like, or a light-emitting device for promoting the growth of plants such as vegetables.

The oxide phosphor having the composition represented by Formula (1) preferably emits light with an emission spectrum having a light emission peak wavelength and a full width at half maximum in a range of 150 nm to 280 nm upon irradiation with excitation light, more preferably emits light in a range of 180 nm to 270 nm, and even more preferably in a range of 185 nm to 260 nm. In the present specification, a full width at half maximum refers to a width between wavelengths at each of which the emission intensity is 50% of the emission intensity at the light emission peak wavelength indicating the maximum emission intensity in the emission spectrum. Because light absorption and scattering occur in a living body, in order to measure a subtle change in the propagation behavior of light in blood in a living body, light a wide full width at half maximum of the emission spectrum with a light emission peak wavelength and is preferably irradiated. Further, also in a case of measuring information on agricultural products and fruits and vegetables non-destructively, light having a wide full width at half maximum of the emission spectrum with the light emission peak wavelength is preferably irradiated in order to obtain the internal information of the agricultural products and fruits and vegetables. Regarding how the color of an object looks when irradiated with light (hereinafter, also referred to as a “color rendering property”), the light preferably has an emission spectrum in a wide wavelength range, and with a wider full width at half maximum, light having a good color rendering property can be emitted. For example, even in a case of use in a place where work is performed, such as a factory, the emission of light that does not disturb the spectral balance of the light may be required such that a worker can easily carry out the work.

In the oxide phosphor having the composition represented by Formula (1), an element M¹ in Formula (1) is at least one element selected from the group consisting of Na, K, Rb, and Cs, may be at least one element selected from the group consisting of Na, K, and Rb, or may contain two or more elements. In Formula (1), a variable s representing the molar ratio of the element M¹ satisfies a range of 0 to 0.5 (0≤s≤0.5), may satisfy a range of 0 to 0.3 (0≤s≤0.3), or the variable s may be 0≤s≤0).

In the oxide phosphor, an element M² in Formula (1) may be at least one element selected from the group consisting of Ca, Sr, and Ba, excluding Zn, and may also contain two or more elements. When the element M² in Formula (1) is at least one element selected from the group consisting of Ca, Sr, and Ba, in Formula (1), as a variable t and a variable u representing the molar ratio of the element M², the variable t is in a range of 0 to 1.0 (0≤t≤1.0), may satisfy a range of 0 to 0.5 (0≤t≤0.5), may satisfy a range of 0 to 0.3 (0≤t≤0.3), or may satisfy a range of 0.01 to 0.3 (0.01≤t≤0.3).

In the oxide phosphor, in the composition represented by Formula (1), in a case in which the element M² is at least one element selected from the group consisting of Ca, Sr, and Ba, excluding Zn, as the variable t and the valuable u representing the molar ratio of the element M², the variable t may satisfy a range of 0 to 0.2 (0≤t≤0.2), may satisfy a range of 0 to 0.1 (0≤t≤0.1), may satisfy a range of 0 to 0.05 (0≤t≤0.05), or the valuable t may satisfy 0 (t=0). In Formula (1), the variable u represents the mole number of the oxide phosphor having the composition represented by the Formula (1b) with respect to 1 mol of the oxide phosphor having the composition represented by the Formula (1a). In Formula (1), in a case in which the variable t representing the element M² is 0 (t=0), the variable u preferably satisfies a range of 0.03 to 5 (0.03≤u≤5), more preferably satisfies a range of 0.05 to 4.5 (0.05≤u≤4.5), and even more preferably satisfies a range of 0.05 to 4 (0.05≤u≤4). In a case in which the variable t representing the element M² in Formula (1) is 0 (t=0) and the variable u satisfies a range of 0.03 to 5 (0.03≤u≤5), the oxide phosphor having the composition represented by Formula (1) can emit light with a higher emission intensity in a red to near-infrared wavelength range upon irradiation with excitation light.

In the oxide phosphor, in the composition represented by Formula (1), when the mole number of the oxide phosphor having the composition represented by the Formula (1b) changes with respect to 1 mol of the oxide phosphor having the composition represented by the Formula (1a), a variable w representing the molar ratio of Ga, the molar ratio of an element M³, or the molar ratio of a total of Ga and the element M³ also changes. In the oxide phosphor having the composition represented by Formula (1), the variable w representing the molar ratio of Ga, the molar ratio of the element M³, or the molar ratio of the total of Ga and the element M³ in Formula (1) satisfies a range of 5.1 to 25 (5.1≤w≤25), may satisfy a range of 5.1 to 15 (5.1≤w≤15), may satisfy a range of 5.1 to 13 (5.1≤w≤13), and may satisfy a range of 5.4 to 13 (5.4≤w≤13). When the variable w in Formula (1) satisfies a range of 5.1 to 25 (5.1≤w≤25), the oxide phosphor having the composition represented by the Formula (1) can emit light with a higher emission intensity in a red to near-infrared wavelength range upon irradiation with excitation light.

In the oxide phosphor, in the composition represented by Formula (1), the element M³ is at least one element selected from the group consisting of Al and Sc, and may be two elements. In the oxide phosphor, the element M³ in Formula (1) may be Al. In the oxide phosphor, in a variable v and the variable w representing the molar ratio of the element M³ in Formula (1), the variable v satisfies a range of 0 to 1.0 (0≤v≤1.0), or may satisfy a range of 0 to 0.8 (0≤v≤0.8), or may satisfy a range of 0 to 0.5 (0≤v≤0.5), or may satisfy a range of 0 to 0.3 (0≤v≤0.3), or the variable v may be 0 (v=0).

In the oxide phosphor, in Formula (1), the ratio u/w, in which the variable u represents the molar ratio of Mg or the molar ratio of a total of Mg and M², and the variable w represents the molar ratio of Ga or the molar ratio of the total of Ga and M³, satisfies a range of 0.005 to 0.4 (0.005≤u/w≤0.4), or may satisfy a range of 0.008 to 0.35 (0.008≤u/w≤0.35), or may satisfy a range of 0.009 to 0.32 (0.009≤u/w≤0.32). When the ratio u/w of the variable u to the variable w in Formula (1) satisfies a range of 0.005 to 0.4 (0.005≤u/w≤0.4), the oxide phosphor can emit light with a higher emission intensity in a red to near-infrared wavelength range upon irradiation with excitation light.

In the oxide phosphor, a variable x representing the molar ratio of oxygen (O) in Formula (1) may vary depending on the mole number of the oxide phosphor having the composition represented by Formula (1b) combined with 1 mol of the oxide phosphor having the composition represented by Formula (1a). In the oxide phosphor, the variable x representing the molar ratio of oxygen (O) in Formula (1) satisfies a range of 8.2 to 48 (8.2≤x≤48). The oxide phosphor, when the variable x in Formula (1) is in a range of 8.2 to 48 (8.2≤x≤48), can be an oxide phosphor having the composition represented by Formula (1), in which the oxide phosphor having the composition represented by Formula (1b) is combined in a range of 0.05 mol to 10 mol with respect to 1 mol of the oxide phosphor having the composition represented by Formula (1a).

In the oxide phosphor having the composition represented by Formula (1), an element M⁴ in Formula (1) is an activating element together with Cr. In the oxide phosphor having the composition represented by Formula (1), the element M⁴ is at least one element selected from the group consisting of Ni, Ce, Eu, Fe, Mn, Nd, Tm, Ho, Er, and Yb. In the oxide phosphor having the composition represented by Formula (1), the element M⁴ may contain Ni as an essential element and at least one element selected from the group consisting of Ce, Eu, Fe, Mn, Nd, Tm, Ho, Er, and Yb. In the oxide phosphor having the composition represented by Formula (1), the element M⁴ may be Ni.

In the oxide phosphor, a variable z representing the molar ratio of the element M⁴ in Formula (1) satisfies a range of 0 to 0.3 (0≤z≤0.3), may satisfy a range of 0 to 0.2 (0≤z≤0.2), or may satisfy a range of 0 to 0.1 (0≤z≤0.1) when Li is taken as 1 or the total of Li and M¹ is taken as 1. In a case in which the element M⁴ does not contain Ni, the oxide phosphor does not necessarily contain the element M⁴, and z may satisfy 0 (z=0). In the oxide phosphor, in a case in which the element M⁴ in Formula (1) contains two or more elements, the variable z represents the total molar ratio of the two or more elements contained in the element M⁴. In the oxide phosphor, in Formula (1), z representing the molar ratio of the element M⁴ as an activating element is a number smaller than the variable y representing the molar ratio of Cr as an activating element (y>z). In the oxide phosphor, the variable y and the variable z in Formula (1) preferably satisfy a range of 1.5 to 50 (1.5≤y/z≤50), may satisfy a range of 2.0 to 40 (2.0≤y/z≤40), and may satisfy a range of 2.5 to 30 (2.5≤y/z≤30).

In the oxide phosphor, in a case in which the variable t is 0 (t=0) as the variable t and the variable u representing the molar ratio of the element M² in Formula (1), the variable u preferably satisfies a range of 0.05 to 4 (0.05≤u≤4), and the variable w preferably satisfies a range of 5.4 to 13 (5.4≤w≤13). In a case in which the variable t representing the element M² in Formula (1) is 0 (t=0), when the variable u satisfies a range of 0.05 to 4 (0.05≤u≤4) and the variable w satisfies a range of 5.4 to 13 (5.4≤w≤13), the oxide phosphor having the composition represented by Formula (1) can emit light with a higher emission intensity in a red to near-infrared wavelength range upon irradiation with excitation light.

In the oxide phosphor, when the variable s representing the molar ratio of the element M¹ is 0 (s=0), and the variable t is 0 (t=0), as the variable t and the variable u representing the molar ratio of the element M² in Formula (1), the variable u preferably satisfies a range of 0.2 to 4.5 (0.2≤u≤4.5) and the variable w preferably satisfies a range of 5.4 to 13 (5.4≤w≤13). In a case in which the variable s is 0 (s=0) and the variable t is 0 (t=0) in Formula (1), when the variable u satisfies a range of 0.2 to 4.5 (0.2≤u≤4.5) and the variable w satisfies a range of 5.4 to 13 (5.4≤w≤13), the oxide phosphor having the composition represented by Formula (1) can emit light with a higher emission intensity in a red to near-infrared wavelength range upon irradiation with excitation light.

In the oxide phosphor, in a case in which the element M⁴ is Ni in Formula (1), the variable z representing the molar ratio of the element M⁴ preferably satisfies a range of 0.001 to 0.2 (0.001≤z≤0.2), and more preferably satisfies a range of 0.002 to 0.1 (0.002≤z≤0.1) when Li is taken as 1 or the total of Li and M¹ is taken as 1. In the composition represented by Formula (1), in a case in which the element M⁴ is Ni and the variable z satisfies a range of 0.001 to 0.2 (0.001≤z≤0.2), first, Cr absorbs the energy of excitation light, and the energy absorbed by Cr is transferred to Ni and thus Ni is efficiently excited, and the oxide phosphor can emit light with an emission spectrum having a light emission peak wavelength in a red to near-infrared wavelength range and a wide full width at half maximum.

In the oxide phosphor, as the variable t and the variable u representing the molar ratio of the element M² in Formula (1), the variable t may satisfy a range of 0.4 to 0.6 (0.4≤t≤0.6), and the variable u may satisfy a range of 0.2 to 5 (0.2≤u≤5). The oxide phosphor having the composition represented by Formula (1) which contains the element M² in Formula (1), when the variable t satisfies a range of 0.4 to 0.6 (0.4≤t≤0.6) and the variable u satisfies a range of 0.2 to 5 (0.2≤u≤5), can emit light with an emission spectrum having a light emission peak wavelength in a range of 820 nm to 860 nm upon irradiation with excitation light. The oxide phosphor, which contains the element M² in Formula (1), when the variable t satisfies a range of 0.4 to 0.6 (0.4≤t≤0.6) and the variable u satisfies a range of 0.2 to 5 (0.2≤u≤5), emits light with an emission spectrum having a light emission peak wavelength and a full width at half maximum in a range of 200 nm to 280 nm. The oxide phosphor, which contains the element M² in Formula (1), when the variable t satisfies a range of 0.4 to 0.6 (0.4≤t≤0.6) and the variable u satisfies a range of 0.2 to 5 (0.2≤u≤5), may emit light having a light emission peak wavelength in a range of 830 nm to 850 nm upon irradiation with excitation light. The oxide phosphor, which contains the element M² in Formula (1), when the variable t satisfies a range of 0.4 to 0.6 (0.4≤t≤0.6) and the variable u satisfies a range of 0.2 to 5 (0.2≤u≤5), can emit light that has a light emission peak wavelength within a desired range, that facilitates acquisition of in vivo information or information on agricultural products, fruits and vegetables non-destructively, and has an excellent color rendering property.

In the oxide phosphor, the element M² in Formula (1) may contain Zn. In the oxide phosphor, in a case in which the element M² contains Zn in Formula (1), as the variable t and the variable u representing the molar ratio of the element M², the variable t may satisfy a range of 0.4 to 0.6 (0.4≤t≤0.6) and the variable u may satisfy a range of 0.2 to 5 (0.2≤u≤5).

In the oxide phosphor, the element M² in Formula (1) contains Zn, the variable t satisfies 1.0 (t=1.0), and Mg is not necessarily contained. In the oxide phosphor, the element M² in Formula (1) contains Zn and may contain at least one element selected from the group consisting of Ca, Sr, and Ba.

In the oxide phosphor, the element M² in Formula (1) is Zn, the variable t satisfies 1.0 (t=1.0), and Mg is not necessarily contained. In a case in which the element M² in Formula (1) is Zn and the variable t satisfies 1.0 (t=1.0), the oxide phosphor preferably emits light with an emission spectrum having a light emission peak wavelength in a range of 700 nm to 860 nm upon irradiation with excitation light.

The light-emitting device includes the oxide phosphor having the composition represented by Formula (1), and a light-emitting element that has a light emission peak wavelength in a range of 365 nm to 650 nm and irradiates the oxide phosphor with excitation light. The oxide phosphor is preferably included in a wavelength conversion member, and the wavelength conversion member may contain a light-transmissive material.

A semiconductor element can be used as the light-emitting element that irradiates the oxide phosphor with excitation light. For example, a nitride semiconductor can be selected as the material for a light-emitting element that emits green and blue light. As the material for a semiconductor structure constituting the light-emitting element, In_{X}Al_{Y}Ga_{1-X-Y}N (0≤X≤1, 0≤Y≤1, X+Y≤1) or the like can be used. As the material for a light-emitting element that emits red light, for example, a gallium-aluminum-arsenic-based semiconductor or an aluminum-indium-gallium-phosphorus-based semiconductor can be selected. For example, an LED chip or an LD chip is preferably used as the light-emitting element.

The light-emitting element may have a light emission peak wavelength in a range of 365 nm to 650 nm, may have a light emission peak wavelength in a range of 365 nm to 500 nm, may have a light emission peak wavelength in a range of 370 nm to 490 nm, and may have a light emission peak wavelength in a range of 375 nm to 480 nm. Alternatively, the light-emitting element may have a light emission peak wavelength in a range of more than 500 nm to 650 nm, may have a light emission peak wavelength in a range of 510 nm to 650 nm, or may have a light emission peak wavelength in a range of 520 nm to 650 nm. The use of a light-emitting element as an excitation light source for the oxide phosphor allows for obtaining a light-emitting device that emits mixed color light in a desired wavelength range, the mixed color light including light from the light-emitting element and fluorescence from a phosphor including the oxide phosphor. The full width at half maximum of the light emission peak in the emission spectrum of the light-emitting element may be, for example, 30 nm or less. As the light-emitting element, for example, a light-emitting element employing a nitride-based semiconductor is preferably used. A stable light-emitting device that exhibits high efficiency and high output linearity with respect to an input and that is strong against mechanical impact can be produced by using, as an excitation light source, a light-emitting element in which a nitride-based semiconductor is used.

The light-emitting device essentially includes a first phosphor containing the oxide phosphor described above, and may further include a phosphor having a different composition. In addition to the first phosphor, the light-emitting device preferably includes at least one phosphor selected from the group consisting of a second phosphor having a light emission peak wavelength of 455 nm or more and less than 495 nm, a third phosphor having a light emission peak wavelength of 495 nm or more and less than 610 nm, a fourth phosphor having a light emission peak wavelength of 610 nm or more and less than 700 nm, and a fifth phosphor having a light emission peak wavelength of 700 nm or more and 1600 nm in the emission spectrum of each of the phosphors. When the light-emitting device includes a light-emitting element and the first phosphor containing the oxide phosphor described above, and also includes at least one phosphor selected from the group consisting of the second phosphor, the third phosphor, the fourth phosphor, and the fifth phosphor, the light-emitting device can be used as a light source that emits light having an emission spectrum in a wavelength range including a portion of a visible to near-infrared wavelength range. The light-emitting device has an emission spectrum similar to that of known tungsten lamps and xenon lamps and can be used as a light source that allows reduction in size compared to tungsten lamps and xenon lamps. Such a small light-emitting device can be mounted on a small mobile device such as a smartphone or a smartwatch, and can be used for physical condition management or the like when in vivo information is obtained.

Such a light-emitting device can be used, for example, in a reflection spectroscopic measurement device, or in an illumination device that can non-destructively measure inside a living body, fruits and vegetables, or the like and that requires light having a good color rendering property.

The second phosphor, which has a composition different from the first phosphor including the oxide phosphor described above, preferably includes at least one type of phosphor selected from the group consisting of a phosphate phosphor having a composition represented by Formula (2a) below, an aluminate phosphor having a composition represented by Formula (2b) below, and an aluminate phosphor having a composition represented by Formula (2c) below, and the second phosphor may include two or more types of these phosphors.

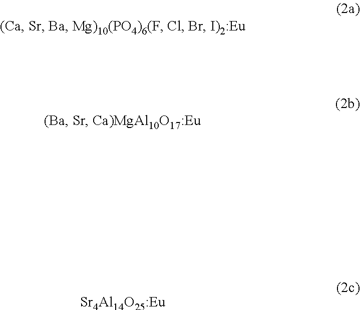

In the present specification, a plurality of elements separated by commas (,) in a compositional formula means that at least one element of the elements is contained in the composition.

The third phosphor preferably includes at least one type of phosphor selected from the group consisting of a silicate phosphor having a composition represented by Formula (3a) below, an aluminate phosphor or gallate phosphor having a composition represented by Formula (3b) below, a β-sialon phosphor having a composition represented by Formula (3c) below, a cesium lead halide phosphor having a composition represented by Formula (3d) below, and a nitride phosphor having a composition represented by Formula (3e) below, and the third phosphor may include two or more types of these phosphors. When the third phosphor includes two or more types of phosphors, the two or more types of third phosphors are preferably phosphors having light emission peak wavelengths in different ranges within a range of 495 nm or more and less than 610 nm.

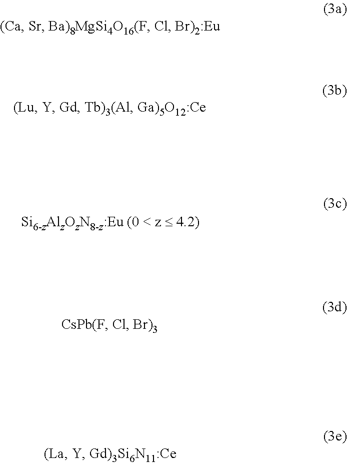

The fourth phosphor preferably includes at least one type of phosphor selected from the group consisting of a nitride phosphor having a composition represented by Formula (4a) below, a fluorogermanate phosphor having a composition represented by Formula (4b) below, an oxynitride phosphor having a composition represented by Formula (4c) below, a fluoride phosphor having a composition represented by Formula (4d) below, a fluoride phosphor having a composition represented by Formula (4e) below, a nitride phosphor having a composition represented by Formula (4f) below, and a nitride phosphor having a composition represented by Formula (4g) below, and the fourth phosphor may include two or more types of these phosphors. When the fourth phosphor includes two or more types of phosphors, the two or more types of fourth phosphors are preferably phosphors having light emission peak wavelengths in respectively different ranges within a range of 610 nm or more and less than 700 nm.

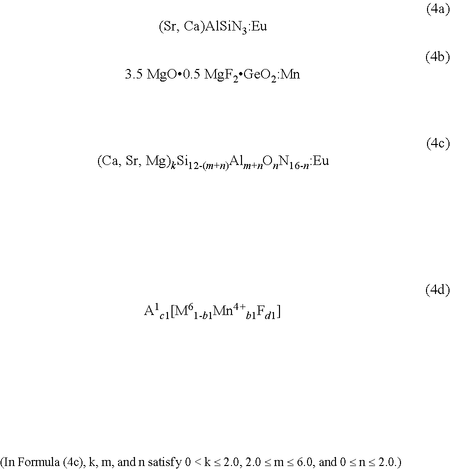

(In Formula (4d), A¹ contains at least one ion selected from the group consisting of K⁺, Li⁺, Na⁺, Rb⁺, Cs⁺, and NH₄⁺, and among these, K⁺ is preferable. M⁶ contains at least one element selected from the group consisting of group 4 elements and group 14 elements, and among these, Si and Ge are preferable. In addition, b1 satisfies 0<b1<0.2, c1 is an absolute value of the electric charge of the [M⁶_{1-b1}Mn⁴⁺_{b1}F_{d1}] ion, and d1 satisfies 5<d1<7.)

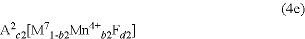

(In Formula (4e), A² contains at least one ion selected from the group consisting of K⁺, Li⁺, Na⁺, Rb⁺, Cs⁺, and NH₄⁺, and among these, K⁺ is preferable. M⁷ contains a group 13 element and may further contain at least one element selected from the group consisting of group 4 elements and group 14 elements. The group 13 element is preferably Al, and the group 14 element is preferably Si. In addition, b2 satisfies 0<b2<0.2, c2 is an absolute value of the electric charge of the [M⁷_{1-b2}Mn⁴⁺_{b2}F_{d2}] ion, and d2 satisfies 5<d2<7.)

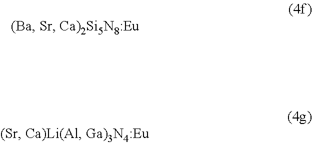

The fifth phosphor preferably includes at least one phosphor selected from the group consisting of a gallate phosphor having a composition represented by Formula (5a) below, an aluminate phosphor having a composition represented by Formula (5b) below, a phosphor having a composition represented by Formula (5c) below that is different in composition from the above oxide phosphor, a phosphor having a composition represented by Formula (5d) below that is different in composition from the above oxide phosphor, a phosphor having a composition represented by Formula (5e) below that is different in composition from the above oxide phosphor, a phosphor having a composition represented by Formula (5f) below that is different in composition from the above oxide phosphor, a phosphor having a composition represented by Formula (5g) below that is different in composition from the above oxide phosphor, a phosphor having a composition represented by Formula (5h) below that is different in composition from the above oxide phosphor, a phosphor having a composition represented by Formula (5i) below that is different in composition from the above oxide phosphor, a phosphor having a composition represented by Formula (5j) below that is different in composition from the above oxide phosphor, a phosphor having a composition represented by Formula (5k) below that is different in composition from the above oxide phosphor, a phosphor having a composition represented by Formula (5l) below that is different in composition from the above oxide phosphor, a phosphor having a composition represented by Formula (5m) below that is different in composition from the above oxide phosphor, and a phosphor having a composition represented by Formula (5n) below that is different in composition from the above oxide phosphor, and may include two or more types of these phosphors.

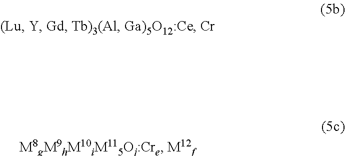

(In Formula (5c), M⁸ is at least one element selected from the group consisting of Li, Na, K, Rb, and Cs; M⁹ is at least one element selected from the group consisting of Mg, Ca, Sr, Ba, and Zn, M¹⁰ is at least one element selected from the group consisting of B, Al, Ga, In, and rare earth elements; M¹¹ is at least one element selected from the group consisting of Si, Ti, Ge, Zr, Sn, Hf, and Pb; M¹² is at least one element selected from the group consisting of Eu, Ce, Tb, Pr, Nd, Sm, Yb, Ho, Er, Tm, Ni, and Mn; and e, f, g, h, i, and j satisfy 0≤e≤0.2, 0≤f≤0.1, f≤e, 0.7≤g≤1.3, 1.5≤h≤2.5, 0.7≤i≤1.3, and 12.9≤j≤15.1.)

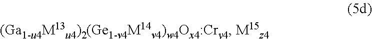

(In Formula (5d), M¹³ is at least one element selected from the group consisting of Al, Sc, and In; M¹⁴ is at least one element selected from the group consisting of Si, Ti, Zr, Sn, and Hf; M¹⁵ is at least one element selected from the group consisting of Ni, Eu, Fe, Mn, Nd, Tm, Ho, Er, and Yb; and u4, v4, w4, x4, y4, and z4 satisfy 0≤u4<1.0, 0≤v4<0.5, 1.0≤w4<3.0, 5≤x4<9, 0.005≤y4<1.0, and 0≤z4<0.5, respectively.)

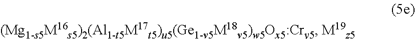

(In Formula (5e), M¹⁶ is at least one element selected from the group consisting of Ca, Sr, Ba, and Zn; M¹⁷ is at least one element selected from the group consisting of Ga, Sc, and In; M¹⁸ is at least one element selected from the group consisting of Si, Ti, Zr, Sn, and Hf; M¹⁹ is at least one element selected from the group consisting of Ni, Ce, Eu, Fe, Mn, Nd, Tm, Ho, Er, and Yb; and s5, t5, u5, v5, w5, x5, y5, and z5 satisfy 0≤s5<1.0, 0≤t5≤1.0, 1.5≤u5<2.5, 0≤v5<0.5, 3.0≤w5<6.0, 11.0≤x5<17.0, 0.005≤y5<1.0, and 0≤z5≤0.5, respectively.)

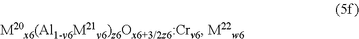

(In Formula (5f), M²⁰ is at least one element selected from the group consisting of alkaline earth metal elements; M²¹ is at least one element selected from the group consisting of group 13 elements excluding Al; M²² is at least one element selected from the group consisting of Mn, Eu, Ce, Tb, Pr, Nd, Sm, Yb, Ho, Er, and Tm; and v6, w6, x6, y6, and z6 satisfy 0.004≤v6<0.8, 0≤w6<0.4, 0.004≤v6+w6<0.8, 1.0≤x6<4.0, 0≤y6<0.7, and 4.0≤z6≤1.50.)

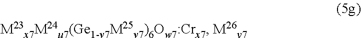

(In Formula (5g), M²³ is at least one element selected from the group consisting of Li, Na, K, Rb, and Cs; M²⁴ is at least one element selected from the group consisting of Ca, Sr, Mg, Ba, and Zn; M²⁵ is at least one element selected from the group consisting of Si, Ti, Zr, Sn, Hf, and Pb; M²⁶ is at least one element selected from the group consisting of Eu, Ce, Tb, Pr, Nd, Sm, Yb, Ho, Er, Tm, Ni, and Mn; and t7, u7, v7, w7, x7, and y7 satisfy 1.5≤t7<2.5, 0.7≤u7<1.3, 0≤v7<0.4, 12.9≤w7<15.1, 0≤x7<0.2, 0≤y7<0.10, and y7≤x7.)

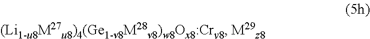

(In Formula (5h), M²⁷ is at least one element selected from the group consisting of Na, K, Rb, and Cs; M²⁸ is at least one element selected from the group consisting of Si, Ti, Zr, Sn, and Hf; M²⁹ is at least one element selected from the group consisting of Ni, Eu, Fe, Mn, Nd, Tm, Ho, Er, and Yb; and u8, v8, w8, x8, y8, and z8 satisfy 0≤u8<0.3, 0<v8<0.5, 3.5≤w8<15, 9≤x8<32, 0.005≤y8<1.0, and 0≤z8<0.5, respectively.)

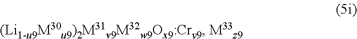

(In Formula (5i), M³⁰ is at least one element selected from the group consisting of Na, K, Rb, and Cs; M³¹ is at least one element selected from the group consisting of Mg, Ca, Sr, Ba, and Zn; M³² is at least one element selected from the group consisting of Si, Ge, Ti, Zr, Sn, and Hf; M³³ is at least one element selected from the group consisting of Ni, Eu, Fe, Mn, Nd, Tm, Ho, Er, and Yb; and u9, v9, w9, x9, y9, and z9 satisfy 0≤u9<1.0, 0.8≤v9<3.0, 1.8≤w9<6, 5.4≤x9<16, 0.005≤y9<1.0, and 0≤z9<0.5, respectively.)

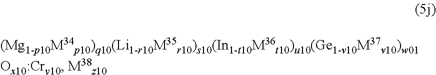

(In Formula (5j), M³⁴ is at least one element selected from the group consisting of Ca, Sr, Ba, and Zn; M³⁵ is at least one element selected from the group consisting of Na, K, Rb, and Cs; M³⁶ is at least one element selected from the group consisting of Al, Ga, and Sc; M³⁷ is at least one element selected from the group consisting of Si, Ti, Zr, Sn, and Hf; M³⁸ is at least one element selected from the group consisting of Ni, Ce, Eu, Fe, Mn, Nd, Tm, Ho, Er, and Yb; and p10, q10, r10, s10, t10, u10, v10, w10, x10, y10, and z10 satisfy 0≤p10≤1.0, 0.1≤q10≤0.9, 0≤r10≤1.0, 0.05≤s10≤0.45, 0≤t10≤0.5, 0.05≤u10≤0.45, 0≤v10≤1.0, 0.8≤w10≤1.3, 2.6≤x10≤3.6, 0.02≤y10≤0.5, 0≤z1≤0.3, and 0.9≤q10+s10+u1≤1.2.)

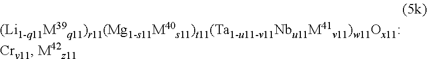

(In Formula (5k), M³⁹ is at least one element selected from the group consisting of Na, K, Rb, and Cs; M⁴⁰ is at least one element selected from the group consisting of Zn, Ca, Sr, and Ba; M⁴¹ is at least one element selected from the group consisting of P, V, Sb, and Bi; M⁴² is at least one element selected from the group consisting of Ni, Ce, Eu, Fe, Mn, Nd, Tm, Ho, Er, and Yb; and q11, r11, s11, t11, u11, v11, w11, x11, y11, and z11 satisfy 0≤q11≤0.5, 0.5≤r11≤3.5, 0≤s11≤0.5, 1.8≤t11≤3.2, 0≤u11≤1.0, 0≤v11≤0.3, 0≤u11+v11≤1.0, 0.8≤w11≤1.2, 5.1≤x11≤6.9, 0.002≤y11≤0.5, and 0≤z11<0.3.)

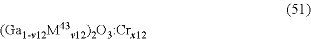

(In Formula (5l), M⁴³ is at least one element selected from the group consisting of Al, In, and rare earth elements; and v12 and x12 satisfy 0≤v12<1.0 and 0.02≤x12<0.3, respectively.)

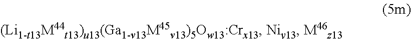

(In Formula (5m), M⁴⁴ is at least one element selected from the group consisting of Na, K, Rb, and Cs; M⁴⁵ is at least one element selected from the group consisting of B, Al, In, and rare earth elements; M⁴⁶ is at least one element selected from the group consisting of Si, Ge, Sn, Ti, Zr, Hf, Bi, V, Nd, and Ta; and t13, u13, v13, w13, x13, y13, and z13 satisfy 0≤t13≤1.0, 0.7≤u13≤1.6, 0≤v13≤1.0, 7.85≤w13≤11.5, 0.05≤x13≤1.2, 0≤y13≤0.5, 0.25≤x13+y13≤1.2, x13>y13, and 0≤z13≤0.5.)

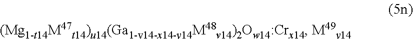

(In Formula (5n), M⁴⁷ is at least one element selected from the group consisting of Ca, Sr, Ba, Ni, and Zn; M⁴⁸ is at least one element selected from the group consisting of B, Al, In, and Sc; M⁴⁹ is at least one element selected from the group consisting of Eu, Ce, Tb, Pr, Nd, Sm, Yb, Ho, Er, Tm, and Mn; and t14, u14, v14, w14, x14, and y14 satisfy 0≤t14≤0.8, 0.7≤u14≤1.3, 0≤v14<0.8, 3.7≤w14≤4.3, 0.02<x14<0.3, 0≤y14≤0.2, and x14>y14, respectively.)

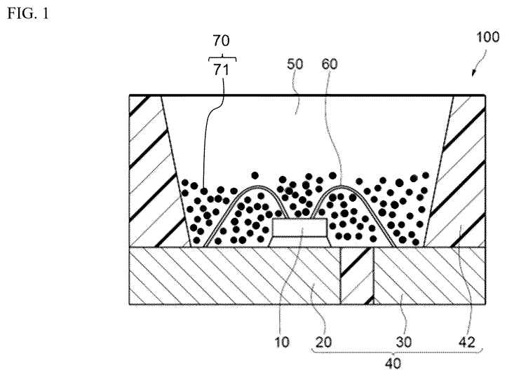

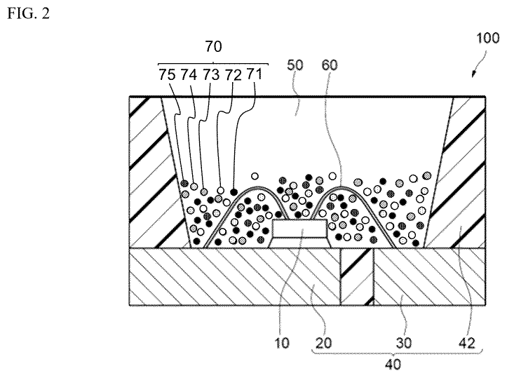

An example of the light-emitting device will be described with reference to the drawings. FIG. 1 is a schematic cross-sectional view illustrating one example of a first configurational example of a light-emitting device. FIG. 2 is a schematic cross-sectional view illustrating another example of the first configurational example of the light-emitting device.

As illustrated in FIG. 1, a light-emitting device 100 includes a molded body 40 having a recessed portion, a light-emitting element 10 serving as an excitation light source, and a wavelength conversion member 50 covering the light-emitting element 10. The molded body 40 is formed by integrally molding a first lead 20, a second lead 30, and a resin portion 42 containing a thermoplastic resin or a thermosetting resin. In the molded body 40, at least the first lead 20 and the second lead 30 constitute a surface defining a bottom of the recessed portion, and at least the resin portion 42 constitutes a surface defining a lateral side of the recessed portion. The light-emitting element 10 is mounted on the surface defining the bottom of the recessed portion of the molded body 40. The light-emitting element 10 includes a pair of positive and negative electrodes, and the pair of the positive and negative electrodes are electrically connected to the first lead 20 and the second lead 30 respectively via wires 60. The light-emitting element 10 is covered with the wavelength conversion member 50. The wavelength conversion member 50 preferably includes a phosphor 70 that converts the wavelength of light emitted from the light-emitting element 10, and a light-transmissive material. The phosphor 70 includes, as an essential component, a first phosphor 71 including an oxide phosphor. The oxide phosphor included in the first phosphor 71 contains an oxide phosphor having the composition represented by Formula (1). The phosphor 70 may include a phosphor having a composition different from the first phosphor 71. As illustrated in FIG. 2, the phosphor 70 preferably includes at least one type of phosphor selected from the group consisting of a second phosphor 72, a third phosphor 73, a fourth phosphor 74, and a fifth phosphor 75, which are described above, and may include two or more types of these phosphors. The phosphor 70 includes the first phosphor 71 as an essential component, and may include the second phosphor 72, the third phosphor 73, the fourth phosphor 74, and the fifth phosphor 75. The wavelength conversion member 50 also functions as a member for protecting the light-emitting element 10, the wire 60, the phosphor 70, and the like from the external environment. The light-emitting device 100 receives a supply of power from the outside via the first lead 20 and the second lead 30, and thereby emits light.

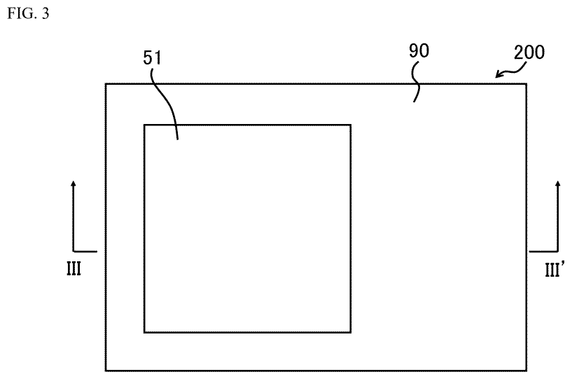

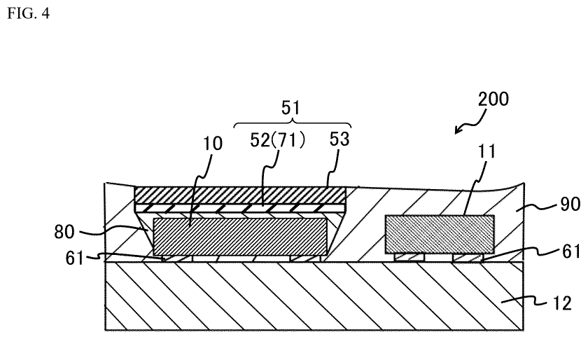

FIGS. 3 and 4 illustrate a second configurational example of a light-emitting device. FIG. 3 is a schematic plan view illustrating a light-emitting device 200. FIG. 4 is a schematic cross-sectional view taken along line III-III′ of the light-emitting device 200 illustrated in FIG. 3. The light-emitting device 200 includes a light-emitting element 10 having a light emission peak wavelength in a range of 365 nm to 650 nm and a wavelength conversion member 51. The wavelength conversion member 51 includes a wavelength conversion body 52 including a first phosphor 71 that is excited by light from the light-emitting element 10 to emit light, and a light-transmissive body 53 disposed on an emission surface side of the wavelength conversion body 52. The light-emitting element 10 is flip-chip mounted on a substrate 12 via a bump, which is a conductive member 61. The wavelength conversion body 52 of the wavelength conversion member 51 is disposed on the light-emitting surface of the light-emitting element 10 via an adhesive layer 80. The lateral surfaces of the light-emitting element 10 and the wavelength conversion member 51 are covered with a cover member 90 that reflects light. The wavelength conversion body 52 adapted to be excited by light from the light-emitting element 10 and essentially includes a first phosphor 71 that includes an oxide phosphor including phosphor particles including a host crystal, containing Ga and oxygen, an activating element, and first compound particles and/or second compound particles disposed on surfaces of the phosphor particles. The oxide phosphor included in the first phosphor 71 contains at least one type of phosphor particles selected from the group consisting of phosphor particles having the composition represented by Formula (1), phosphor particles having the composition represented by Formula (2), and phosphor particles having the composition represented by Formula (3). The oxide phosphor included in the first phosphor may include two or more types of oxide phosphors containing phosphor particles having different compositions. The wavelength conversion body 52 may include at least one type of phosphor selected from the group consisting of the second phosphor, the third phosphor, the fourth phosphor, and the fifth phosphor. The light-emitting element 10 receives a supply of power from outside of the light-emitting device 200 through the conductive member 61 and a conductive member formed on the substrate 12, and can cause the light-emitting device 200 to emit light. The light-emitting device 200 may include a semiconductor element 11 such as a protective element for protecting the light-emitting element 10 from damage caused by the application of excessive voltage. The semiconductor element 11 may be mounted on the substrate 12 via the conductive member 61. The cover member 90 is disposed so as to cover the semiconductor element 11, for example. Each of the members used in the light-emitting device will be described below. For details, reference may be made to the disclosure of Japanese Patent publication No. 2014-112635 A, for example.

Examples of the light-transmissive material constituting the wavelength conversion body together with the phosphor include at least one material selected from the group consisting of resin, glass, and an inorganic substance. As the resin, at least one type of resin selected from the group consisting of silicone resin, epoxy resin, phenol resin, polycarbonate resin, acrylic resin, and modified resins thereof can be used. The silicone resin and the modified silicone resin are preferable in terms of exhibiting good heat resistance and light resistance. The wavelength conversion member may include, in addition to the phosphors and the light-transmissive material, a filler, a colorant, and a light diffusing material as necessary. Examples of the filler include silicon oxide, barium titanate, titanium oxide, and aluminum oxide.

A plate-shape body made of a light-transmissive material such as glass or resin can be used as the light-transmissive body. Examples of the glass include borosilicate glass and quartz glass. Examples of the resin include a silicone resin and an epoxy resin. When the wavelength conversion member includes a substrate, the substrate is preferably made of an insulating material that does not easily transmit light from the light-emitting element or external light. Examples of the material of the substrate include ceramics such as aluminum oxide and aluminum nitride, and resins such as phenol resin, epoxy resin, polyimide resin, bismaleimide triazine resin (BT resin), and polyphthalamide (PPA) resin. When an adhesive layer is interposed between the light-emitting element and the wavelength conversion member, the adhesive constituting the adhesive layer is preferably made of a material that can optically couple the light-emitting element and the wavelength conversion member. The material constituting the adhesive layer is preferably at least one type of resin selected from the group consisting of epoxy resin, silicone resin, phenol resin, and polyimide resin. The light-transmissive body is not necessarily disposed in the wavelength conversion member.

Examples of the semiconductor element provided as necessary in the light-emitting device include a transistor for controlling the light-emitting element and a protective element for reducing damage or performance deterioration of the light-emitting element due to the application of excessive voltage. An example of the protective element is a Zener diode. When the light-emitting device includes a cover member, an insulating material is preferably used as the material of the cover member. More specific examples of the material of the cover member include phenol resin, epoxy resin, bismaleimide triazine resin (BT resin), polyphthalamide (PPA) resin, and silicone resin. A colorant, a phosphor, or a filler may be added to the cover member as necessary. In the light-emitting device, a bump may be used as the conductive member. Au or an Au alloy can be used as the material of the bump, and eutectic solder (Au—Sn), Pb—Sn, lead-free solder, or the like can be used as the other conductive member.

An example of a method for manufacturing a light-emitting device according to the first configurational example will be described. For details, reference may be made to the disclosure of Japanese Patent Publication No. 2010-062272 A, for example. The method for manufacturing the light-emitting device preferably includes a step of providing a molded body, a step of disposing a light-emitting element, a step of disposing a wavelength conversion member-forming composite, and a step of forming a resin package. In a case in which a collective molded body including a plurality of recessed portions is used as the molded body, a singulating step may be included after the resin package forming step to separate the resin package into respective unit regions.

In the step of providing the molded body, a plurality of leads are integrally molded using a thermosetting resin or a thermoplastic resin to provide a molded body including a recessed portion with surfaces defining lateral sides and a bottom of the recessed portion. The molded body may be formed from a collective base member including a plurality of recessed portions.

In the step of disposing the light-emitting element, the light-emitting element is disposed on the surface defining the bottom of the recessed portion of the molded body, and the positive and negative electrodes of the light-emitting element are connected to the first lead and the second lead via wires.

In the step of disposing the wavelength conversion member-forming composition, the wavelength conversion member-forming composition is disposed in the recessed portion of the molded body.

In the resin package forming step, the wavelength conversion member-forming composition disposed in the recessed portion of the molded body is cured to form the resin package, so that the light-emitting device is manufactured. When a molded body composed of a collective base member including a plurality of recessed portions is used, after the resin package forming step, the collective base member including the plurality of recessed portions is separated into each resin package in each unit region in the singulation step, so that individual light-emitting devices are manufactured. In this manner, the light-emitting device illustrated in FIG. 1 or FIG. 2 can be manufactured.

An example of a method for manufacturing a light-emitting device of the second configurational example will now be described. For details, reference may be made to the disclosure of Japanese Patent Publication No. 2014-112635 A or Japanese Patent Publication No. 2017-117912 A, for example. The method for manufacturing the light-emitting device preferably includes a step of disposing a light-emitting element, a step of disposing a semiconductor element as necessary, a step of forming a wavelength conversion member including a wavelength conversion body, a step of adhering the light-emitting element and the wavelength conversion member, and a step of forming a cover member.

For example, in the step of disposing the light-emitting element, the light-emitting element is disposed on a substrate. The light-emitting element and the semiconductor element are, for example, flip-chip mounted on the substrate. Subsequently, in the step of forming the wavelength conversion member including the wavelength conversion body, the wavelength conversion body may be obtained by forming a plate-shaped, sheet-shaped, or layer-shaped wavelength conversion body on one surface of a light-transmissive body by a printing method, an adhesion method, a compression molding method, or an electrodeposition method. For example, in the printing method, a wavelength conversion member including a wavelength conversion body can be used by printing a wavelength conversion body-forming composite including a phosphor and a resin serving as a binder or a solvent on one surface of a light-transmissive body. Subsequently, in the step of adhering the light-emitting element and the wavelength conversion member to each other, the wavelength conversion member is bonded on the light-emitting element through an adhesive layer with the wavelength conversion member facing the light-emitting surface of the light-emitting element. Subsequently, in the step of forming the cover member, the lateral surfaces of the light-emitting element and the wavelength conversion member are covered with the cover member composite. The cover member reflects light emitted from the light-emitting element, and is preferably formed such that when the light-emitting device further includes a semiconductor element, the semiconductor element is embedded in the cover member. In this manner, the light-emitting device illustrated in FIGS. 3 and 4 can be manufactured.

A method for producing an oxide phosphor includes providing a raw material mixture including a first compound containing Li, a second compound containing Mg and/or a third compound containing the element M², a fourth compound containing Ga or a fifth compound containing the element M³, and a sixth compound containing Cr, and heat-treating the raw material mixture at a temperature in a range of 1200° C. to 1700° C. in an atmosphere containing oxygen to produce an oxide phosphor.

The raw material mixture may contain one of the second compound containing Mg or the third compound containing the element M². The raw material mixture may contain one of the fourth compound containing Ga or the fifth compound containing the element M³.

The raw material mixture may include a seventh compound containing the element M¹ as necessary, and an eighth compound containing the element M⁴ as necessary.

In the raw material mixture, the second compound containing Mg and/or the third compound containing the element M² is preferably adjusted and mixed such that when the molar ratio of Li or the molar ratio of the total of Li and M¹ is taken as 1 in 1 mol of the composition of the oxide phosphor to be obtained, the molar ratio u, which is the molar ratio of Mg, the molar ratio of the element M², or the molar ratio of the total of Mg and the element M², is in a range of 0.05 to 10 (0.05≤u≤10). In the raw material mixture, when the molar ratio of the total of Mg and the element M² is taken as 1, the raw material mixture may be obtained by adjusting the molar ratio t of the element M² to be in a range of 0 to 1.0 (0≤t≤1.0). When the molar ratio of the total of Mg and the element M² is taken as 1, in a case in which the molar ratio t of the element M² exceeds 0, the raw material mixture may contain the third compound containing the element M². When the molar ratio of the total of Mg and the element M² is taken as 1, in a case in which the molar ratio t of the element M² is 1.0, the raw material mixture does not necessarily contain the second compound containing Mg.

In the raw material mixture, the fourth compound containing Ga and/or the fifth compound containing the element M³ is preferably adjusted and mixed such that when the molar ratio of Li or the molar ratio of the total of Li and M¹ is taken as 1 in 1 mol of the composition of the oxide phosphor to be obtained, the molar ratio w, which is the molar ratio of Ga, the molar ratio of the element M³, or the molar ratio of the total of Ga and the element M³, is in the range of 5.1 to 25 (5.1≤w≤25). In the raw material mixture, when the molar ratio of the total of Ga and the element M³ is taken as 1, the raw material mixture may be obtained by adjusting the molar ratio v of the element M³ to be in a range of 0 to 1.0 (0≤v≤1.0). When the molar ratio of the total of Ga and the element M³ is taken as 1, in a case in which the molar ratio v of the element M³ exceeds 0, the raw material mixture may contain a fifth compound containing the element M³. When the total molar ratio of Ga and the element M³ is taken as 1, in a case in which the molar ratio t of the element M³ is 1.0, the raw material mixture does not necessarily contain the fourth compound containing Ga.

In the raw material mixture, at least one compound selected from the group consisting of the second compound containing Mg and the third compound containing element M², and at least one compound selected from the group consisting of the fourth compound containing Ga and the fifth compound containing the element M³ are preferably adjusted and mixed such that when the molar ratio of Li or the molar ratio of the total of Li and M¹ is taken as 1 in 1 mol of the composition of the oxide phosphor to be obtained, the ratio (u/w) of the molar ratio u, which is the molar ratio of Mg, the molar ratio of the element M², or the molar ratio of the total of Mg and the element M², to the molar ratio w, which is the molar ratio of Ga, the molar ratio of the element M³, or the molar ratio of the total of Ga and the element M³, is in a range of 0.005 to 0.4 (0.005≤u/w≤0.4).

In the raw material mixture, the raw materials are preferably adjusted and mixed such that when the molar ratio of Li or the molar ratio of the total of Li and M¹ is taken as 1 in 1 mol of the composition of the oxide phosphor to be obtained, the molar ratio y of Cr with respect to the molar ratio of Li or the molar ratio of the total of Li and M¹ is in a range of 0.02 to 0.5 (0.02≤y≤0.5).

In the raw material mixture, the seventh compound containing the element M¹ may be adjusted and mixed as needed such that when the molar ratio of the total of Li and the element M¹ is taken as 1, the molar ratio s of the element M¹ is in a range of 0 to 0.5 (0≤s≤0.5). When the molar ratio of the total of Li and the element M¹ is taken as 1, in a case in which the molar ratio s of the element M¹ exceeds 0, the raw material mixture may contain the seventh compound containing the element M¹.

In the raw material mixture, the eighth compound containing the element M⁴ may be adjusted and mixed as needed such that when the molar ratio of Li or the molar ratio of the total of Li and the element M¹ is taken as 1 in 1 mol of the composition of the oxide phosphor to be obtained, the molar ratio z of the element M⁴ is in a range of 0 to 0.3 (0≤z≤0.3) with respect to the molar ratio of Li or the molar ratio of the total of Li and M¹. When the molar ratio z of the element M⁴ exceeds 0, the raw material mixture may contain the eighth compound containing the element M⁴. In the raw material mixture, the eighth compound containing the element M⁴ may be adjusted and mixed as needed such that the molar ratio z of the element M⁴ is smaller than the molar ratio y of Cr (y>z).

The first compound containing Li, the second compound containing Mg and/or the third compound containing the element M², the fourth compound containing Ga and/or the fifth compound containing the element M³, the sixth compound containing Cr, the optionally-contained seventh compound containing the element M¹, and the optionally-contained eighth compound containing the element M⁴, which serve as the raw materials, are preferably oxides, carbonates, chlorides, or hydrates thereof.

The first compound containing Li, the second compound containing Mg and/or the third compound containing the element M², the fourth compound containing Ga and/or the fifth compound containing the element M³, the sixth compound containing Cr, the optionally-contained seventh compound containing the element M¹, and the optionally-contained eighth compound containing the element M⁴, which serve as the raw materials, may be mixed using a mixer to obtain a raw material mixture. As a mixer, in addition to a ball mill commonly used industrially, a vibration mill, a roll mill, a jet mill, or the like can be used.

The raw material mixture may include a flux. When the raw material mixture includes a flux, the reaction between the raw materials is further promoted and the solid-phase reaction proceeds more uniformly, and thereby a phosphor having a large particle size and better light-emitting characteristics can be obtained. When the heat treatment temperature for obtaining the phosphor is substantially equivalent to the temperature at which the liquid phase of the compound used as the flux is formed, the reaction between the raw materials is promoted by the flux. As the flux, a halide containing at least one element selected from the group consisting of rare earth elements, alkaline earth metal elements, and alkali metal elements can be used. Among halides, a fluoride can be used as the flux. When the element contained in the flux is the same element as at least one of the elements constituting the oxide phosphor, the flux can be added as a portion of the raw materials of the oxide phosphor having the target composition such that the composition of the oxide phosphor becomes the target composition, or the flux can be further added after the raw materials are mixed so as to form the target composition.

The raw material mixture can be placed in a crucible or a boat made of carbon such as graphite or of a material such as boron nitride (BN), alumina (Al₂O₃), tungsten (W), or molybdenum (Mo), and then heat-treated in a furnace.

The heat treatment is preferably performed in an atmosphere containing oxygen. The oxygen content in the atmosphere is not particularly limited. The oxygen content in the atmosphere containing oxygen is preferably 5 vol % or more, more preferably 10 vol % or more, and even more preferably 15 vol % or more. The heat treatment is preferably performed in an air atmosphere (oxygen content of 20 vol % or more). When the atmosphere does not contain oxygen, i.e., the oxygen content is less than 1 vol %, an oxide phosphor having a desired composition may not be obtained in some cases.

The temperature for the heat treatment is in a range of 1200° C. to 1700° C., preferably in a range of 1250° C. to 1650° C., and more preferably in a range of 1300° C. to 1600° C. When the heat treatment temperature is in a range of 1200° C. to 1700° C., decomposition due to heat is inhibited, and an oxide phosphor having the target composition and a stable crystal structure is obtained.

In the heat treatment, a retention time at a predetermined temperature may be provided. The retention time may be, for example, in a range of 0.5 hours to 48 hours, in a range of 1 hour to 40 hours, or in a range of 2 hours to 30 hours. Crystal growth can be promoted by setting the retention time to be in a range of 0.5 hours to 48 hours.

The pressure of the heat treatment atmosphere may be standard atmospheric pressure (0.101 MPa), may be 0.101 MPa or higher, or may be a pressurized atmosphere in a range of 0.11 MPa to 200 MPa. In a case in which the heat treatment temperature is high, the crystal structure of the heat-treated product obtained by the heat treatment easily decomposes.

However, decomposition of the crystal structure can be inhibited by carrying out the heat treatment in a pressurized atmosphere.

The heat treatment time can be appropriately selected depending on the heat treatment temperature and the pressure of the atmosphere during the heat treatment, and is preferably in a range of 0.5 hours to 20 hours. Even in a case in which the heat treatment is performed in two or more steps, the heat treatment time for one step is preferably in a range of 0.5 hours to 20 hours. When the heat treatment time is in a range of 0.5 hours to 20 hours, decomposition of the obtained heat-treated product is inhibited, and a phosphor having a stable crystal structure and a desired emission intensity can be obtained. In addition, production cost can be reduced, and the production time can be relatively shortened. The heat treatment time is more preferably in a range of 1 hour to 10 hours, and even more preferably in a range of 1.5 hours to 9 hours.

The heat-treated product obtained by the heat treatment may be subjected to a post-treatment such as pulverization, dispersion, solid-liquid separation, or drying. Solid-liquid separation can be implemented by a method commonly used in industrial applications, such as filtration, suction filtration, pressure filtration, centrifugation, or decantation. Drying can be implemented using a device commonly used in industrial applications, such as a vacuum dryer, a hot air heating dryer, a conical dryer, or a rotary evaporator.

### EXAMPLES

Subject matter of the present disclosure will be specifically described hereinafter by way of Examples. However, the present disclosure is not limited to these Examples.

### Example 1

Raw materials are weighed to achieve 0.74 g of Li₂CO₃, 0.16 g of MgO, 10.1 g of Ga₂O₃, and 0.31 g of Cr₂O₃ (the target composition is LiMg_{0.2}Ga_{5.4}O_{8.8}:Cr_{0.20}, and in the present specification, in the target composition or the composition represented by Formula (1), the molar ratio of an element whose numerical value of the molar ratio is not described is 1. In addition, the molar ratio of Cr or the molar ratio of the element M⁴ in the target composition or the composition represented by Formula (1) is the molar ratio with respect to Li when Li is taken as 1). The raw materials are then mixed for about 10 minutes using an agate mortar and an agate pestle to prepare a raw material mixture. The resultant raw material mixture is placed in an alumina crucible and heat-treated at 1500° C. in an air atmosphere (oxygen content of 20 vol %) at standard atmospheric pressure (0.101 MPa) for 6 hours.

After the heat treatment, the heat-treated product is pulverized to produce an oxide phosphor according to Example 1 having molar ratios similar to those of the target composition.

The oxide phosphor according to Example 1 and oxide phosphors according to Examples 2 to 37 described below have the compositions shown in Table 1 and have the composition represented by Formula (1). In the oxide phosphor according to Example 1, in Formula (1), the variable s is 0 (s=0), the variable t is 0 (t=0), the variable u is 0.2 (u=0.2), the variable v is 0 (v=0), the variable w is 5.4 (w=5.4), the variable x is 8.8 (x=8.8), the variable y is 0.20 (y=0.20), and the variable z is 0 (z=0).

### Example 2

An oxide phosphor according to Example 2 having molar ratios similar to those of the target composition are obtained in the same manner as in Example 1, except that a raw material mixture is prepared by weighing raw materials to achieve 0.74 g of Li₂CO₃, 0.16 g of MgO, 10.1 g of Ga₂O₃, and 0.40 g of Cr₂O₃ (the target composition is LiMg_{0.2}Ga₅₄O_{8.8}:Cr_{0.26}).
In the oxide phosphor according to Example 2, in Formula (1), the variable s is 0 (s=0), the variable t is 0 (t=0), the variable u is 0.2 (u=0.2), the variable v is 0 (v=0), the variable w is 5.4 (w=5.4), the variable x is 8.8 (x=8.8), the variable y is 0.26 (y=0.26), and the variable z is 0 (z=0).

### Example 3

An oxide phosphor according to Example 3 having molar ratios similar to those of the target composition is obtained in the same manner as in Example 1, except that a raw material mixture is prepared by weighing raw materials to achieve 0.74 g of Li₂CO₃, 0.28 g of MgO, 10.7 g of Ga₂O₃, and 0.31 g of Cr₂O₃ (the target composition is LiMg_{0.35}Ga_{5.7}O_{9.4}:Cr_{0.20}).
In the oxide phosphor according to Example 3, in Formula (1), the variable s is 0 (s=0), the variable t is 0 (t=0), the variable u is 0.35 (u=0.35), the variable v is 0 (v=0), the variable w is 5.7 (w=5.7), the variable x is 9.4 (x=9.4), the variable y is 0.20 (y=0.20), and the variable z is 0 (z=0).

### Example 4

An oxide phosphor according to Example 4 having molar ratios similar to those of the target composition is obtained in the same manner as in Example 1, except that a raw material mixture is prepared by weighing raw materials to achieve 0.74 g of Li₂CO₃, 0.28 g of MgO, 10.7 g of Ga₂O₃, and 0.40 g of Cr₂O₃ (the target composition is LiMg_{0.35}Ga_{5.7}O_{9.4}:Cr_{0.26}).
In the oxide phosphor according to Example 4, in Formula (1), the variable s is 0 (s=0), the variable t is 0 (t=0), the variable u is 0.35 (u=0.35), the variable v is 0 (v=0), the variable w is 5.7 (w=5.7), the variable x is 9.4 (x=9.4), the variable y is 0.26 (y=0.26), and the variable z is 0 (z=0).

### Example 5

An oxide phosphor according to Example 5 having molar ratios similar to those of the target composition is obtained in the same manner as in Example 1, except that a raw material mixture is prepared by weighing raw materials to achieve 0.74 g of Li₂CO₃, 0.41 g of MgO, 11.2 g of Ga₂O₃, and 0.31 g of Cr₂O₃ (the target composition is LiMg_{0.5}Ga₆O₁₀: Cr_{0.20}).
In the oxide phosphor according to Example 5, in Formula (1), the variable s is 0 (s=0), the variable t is 0 (t=0), the variable u is 0.5 (u=0.5), the variable v is 0 (v=0), the variable w is 6 (w=6), the variable x is 10 (x=10), the variable y is 0.20 (y=0.20), and the variable z is 0 (z=0).

### Example 6

An oxide phosphor according to Example 6 having molar ratios similar to those of the target composition is obtained in the same manner as in Example 1, except that a raw material mixture is prepared by weighing raw materials to achieve 0.74 g of Li₂CO₃, 0.41 g of MgO, 11.2 g of Ga₂O₃, and 0.40 g of Cr₂O₃ (the target composition is LiMg_{0.5}Ga₆O₁₀: Cr_{0.26}).
In the oxide phosphor according to Example 6, in Formula (1), the variable s is 0 (s=0), the variable t is 0 (t=0), the variable u is 0.5 (u=0.5), the variable v is 0 (v=0), the variable w is 6 (w=6), the variable x is 10 (x=10), the variable y is 0.26 (y=0.26), and the variable z is 0 (z=0).

### Example 7

An oxide phosphor according to Example 7 having molar ratios similar to those of the target composition is obtained in the same manner as in Example 1, except that a raw material mixture is prepared by weighing raw materials to achieve 0.74 g of Li₂CO₃, 0.62 g of MgO, 12.1 g of Ga₂O₃, and 0.31 g of Cr₂O₃ (the target composition is LiMg_{0.75}Ga_{6.5}O₁₁:Cr_{0.20}).
In the oxide phosphor according to Example 7, in Formula (1), the variable s is 0 (s=0), the variable t is 0 (t=0), the variable u is 0.75 (u=0.75), the variable v is 0 (v=0), the variable w is 6.5 (w=6.5), the variable x is 11 (x=11), the variable y is 0.20 (y=0.20), and the variable z is 0 (z=0).

### Example 8

An oxide phosphor according to Example 8 having molar ratios similar to those of the target composition is obtained in the same manner as in Example 1, except that a raw material mixture is prepared by weighing raw materials to achieve 0.74 g of Li₂CO₃, 0.62 g of MgO, 12.1 g of Ga₂O₃, and 0.40 g of Cr₂O₃ (the target composition is LiMg_{0.75}Ga_{6.5}O₁₁:Cr_{0.26}).
In the oxide phosphor according to Example 8, in Formula (1), the variable s is 0 (s=0), the variable t is 0 (t=0), the variable u is 0.75 (u=0.75), the variable v is 0 (v=0), the variable w is 6.5 (w=6.5), the variable x is 11 (x=11), the variable y is 0.26 (y=0.26), and the variable z is 0 (z=0).

### Example 9

An oxide phosphor according to Example 9 having molar ratios similar to those of the target composition is obtained in the same manner as in Example 1, except that a raw material mixture is prepared by weighing raw materials to achieve 0.74 g of Li₂CO₃, 0.81 g of MgO, 13.1 g of Ga₂O₃, and 0.06 g of Cr₂O₃ (the target composition is LiMgGa₇O₁₂:Cr_{0.04}).
In the oxide phosphor according to Example 9, in Formula (1), the variable s is 0 (s=0), the variable t is 0 (t=0), the variable u is 1 (u=1), the variable v is 0 (v=0), the variable w is 7 (w=7), the variable x is 12 (x=12), the variable y is 0.04 (y=0.04), and the variable z is 0 (z=0).

### Example 10

An oxide phosphor according to Example 10 having molar ratios similar to those of the target composition is obtained in the same manner as in Example 1, except that a raw material mixture is prepared by weighing raw materials to achieve 0.74 g of Li₂CO₃, 0.81 g of MgO, 13.1 g of Ga₂O₃, and 0.20 g of Cr₂O₃ (the target composition is LiMgGa₇O₁₂:Cr_{0.13}).
In the oxide phosphor according to Example 10, in Formula (1), the variable s is 0 (s=0), the variable t is 0 (t=0), the variable u is 1 (u=1), the variable v is 0 (v=0), the variable w is 7 (w=7), the variable x is 12 (x=12), the variable y is 0.13 (y=0.13), and the variable z is 0 (z=0).

### Example 11

An oxide phosphor according to Example 11 having molar ratios similar to those of the target composition is obtained in the same manner as in Example 1, except that a raw material mixture is prepared by weighing raw materials to achieve 0.74 g of Li₂CO₃, 0.81 g of MgO, 13.1 g of Ga₂O₃, and 0.31 g of Cr₂O₃ (the target composition is LiMgGa₇O₁₂:Cr_{0.20}).
In the oxide phosphor according to Example 11, in Formula (1), the variable s is 0 (s=0), the variable t is 0 (t=0), the variable u is 1 (u=1), the variable v is 0 (v=0), the variable w is 7 (w=7), the variable x is 12 (x=12), the variable y is 0.20 (y=0.20), and the variable z is 0 (z=0).

### Example 12

An oxide phosphor according to Example 12 having molar ratios similar to those of the target composition is obtained in the same manner as in Example 1, except that a raw material mixture is prepared by weighing raw materials to achieve 0.74 g of Li₂CO₃, 0.81 g of MgO, 13.1 g of Ga₂O₃, and 0.40 g of Cr₂O₃ (the target composition is LiMgGa₇O₁₂:Cr_{0.26}).
In the oxide phosphor according to Example 12, in Formula (1), the variable s is 0 (s=0), the variable t is 0 (t=0), the variable u is 1 (u=1), the variable v is 0 (v=0), the variable w is 7 (w=7), the variable x is 12 (x=12), the variable y is 0.26 (y=0.26), and the variable z is 0 (z=0).

### Example 13

An oxide phosphor according to Example 13 having molar ratios similar to those of the target composition is obtained in the same manner as in Example 1, except that a raw material mixture is prepared by weighing raw materials to achieve 0.74 g of Li₂CO₃, 0.81 g of MgO, 13.1 g of Ga₂O₃, and 0.51 g of Cr₂O₃ (the target composition is LiMgGa₇O₁₂:Cr_{0.33}).
In the oxide phosphor according to Example 13, in Formula (1), the variable s is 0 (s=0), the variable t is 0 (t=0), the variable u is 1 (u=1), the variable v is 0 (v=0), the variable w is 7 (w=7), the variable x is 12 (x=12), the variable y is 0.33 (y=0.33), and the variable z is 0 (z=0).

### Example 14

An oxide phosphor according to Example 14 having molar ratios similar to those of the target composition is obtained in the same manner as in Example 1, except that a raw material mixture is prepared by weighing raw materials to achieve 0.74 g of Li₂CO₃, 0.81 g of MgO, 13.1 g of Ga₂O₃, and 0.62 g of Cr₂O₃ (the target composition is LiMgGa₇O₁₂:Cr_{0.40}).
In the oxide phosphor according to Example 14, in Formula (1), the variable s is 0 (s=0), the variable t is 0 (t=0), the variable u is 1 (u=1), the variable v is 0 (v=0), the variable w is 7 (w=7), the variable x is 12 (x=12), the variable y is 0.40 (y=0.40), and the variable z is 0 (z=0).

### Example 15

An oxide phosphor according to Example 15 having molar ratios similar to those of the target composition is obtained in the same manner as in Example 1, except that a raw material mixture is prepared by weighing raw materials to achieve 0.74 g of Li₂CO₃, 0.81 g of MgO, 13.1 g of Ga₂O₃, and 0.72 g of Cr₂O₃ (the target composition is LiMgGa₇O₁₂:Cr_{0.46}).
In the oxide phosphor according to Example 15, in Formula (1), the variable s is 0 (s=0), the variable t is 0 (t=0), the variable u is 1 (u=1), the variable v is 0 (v=0), the variable w is 7 (w=7), the variable x is 12 (x=12), the variable y is 0.46 (y=0.46), and the variable z is 0 (z=0).

### Example 16

An oxide phosphor according to Example 16 having molar ratios similar to those of the target composition is obtained in the same manner as in Example 1, except that a raw material mixture is prepared by weighing raw materials to achieve 0.74 g of Li₂CO₃, 1.2 g of MgO, 15.0 g of Ga₂O₃, and 0.31 g of Cr₂O₃ (the target composition is LiMg_{1.5}Ga₈O₁₄:Cr_{0.20}).
In the oxide phosphor according to Example 16, in Formula (1), the variable s is 0 (s=0), the variable t is 0 (t=0), the variable u is 1.5 (u=1.5), the variable v is 0 (v=0), the variable w is 8 (w=8), the variable x is 14 (x=14), the variable y is 0.20 (y=0.20), and the variable z is 0 (z=0).

### Example 17

An oxide phosphor according to Example 17 having molar ratios similar to those of the target composition is obtained in the same manner as in Example 1, except that a raw material mixture is prepared by weighing raw materials to achieve 0.74 g of Li₂CO₃, 1.2 g of MgO, 15.0 g of Ga₂O₃, and 0.40 g of Cr₂O₃ (the target composition is LiMg_{1.5}Ga₈O₁₄:Cr_{0.26}).
In the oxide phosphor according to Example 17, in Formula (1), the variable s is 0 (s=0), the variable t is 0 (t=0), the variable u is 1.5 (u=1.5), the variable v is 0 (v=0), the variable w is 8 (w=8), the variable x is 14 (x=14), the variable y is 0.26 (y=0.26), and the variable z is 0 (z=0).

### Example 18

An oxide phosphor according to Example 18 having molar ratios similar to those of the target composition is obtained in the same manner as in Example 1, except that a raw material mixture is prepared by weighing raw materials to achieve 0.74 g of Li₂CO₃, 1.6 g of MgO, 16.8 g of Ga₂O₃, and 0.20 g of Cr₂O₃ (the target composition is LiMg₂Ga₉O₁₆:Cr_{0.13}).
In the oxide phosphor according to Example 18, in Formula (1), the variable s is 0 (s=0), the variable t is 0 (t=0), the variable u is 2 (u=2), the variable v is 0 (v=0), the variable w is 9 (w=9), the variable x is 16 (x=16), the variable y is 0.13 (y=0.13), and the variable z is 0 (z=0).

### Example 19

An oxide phosphor according to Example 19 having molar ratios similar to those of the target composition is obtained in the same manner as in Example 1, except that a raw material mixture is prepared by weighing raw materials to achieve 0.74 g of Li₂CO₃, 1.6 g of MgO, 16.8 g of Ga₂O₃, and 0.40 g of Cr₂O₃ (the target composition is LiMg₂Ga₉O₁₆:Cr_{0.26}).
In the oxide phosphor according to Example 19, in Formula (1), the variable s is 0 (s=0), the variable t is 0 (t=0), the variable u is 2 (u=2), the variable v is 0 (v=0), the variable w is 9 (w=9), the variable x is 16 (x=16), the variable y is 0.26 (y=0.26), and the variable z is 0 (z=0).

### Example 20

An oxide phosphor according to Example 20 having molar ratios similar to those of the target composition is obtained in the same manner as in Example 1, except that a raw material mixture is prepared by weighing raw materials to achieve 0.74 g of Li₂CO₃, 3.2 g of MgO, 24.3 g of Ga₂O₃, and 0.20 g of Cr₂O₃ (the target composition is LiMg₄Ga₁₃O₂₄:Cr_{0.13}).
In the oxide phosphor according to Example 20, in Formula (1), the variable s is 0 (s=0), the variable t is 0 (t=0), the variable u is 4 (u=4), the variable v is 0 (v=0), the variable w is 13 (w=13), the variable x is 24 (x=24), the variable y is 0.13 (y=0.13), and the variable z is 0 (z=0).

### Example 21

An oxide phosphor according to Example 21 having molar ratios similar to those of the target composition is obtained in the same manner as in Example 1, except that a raw material mixture is prepared by weighing raw materials to achieve 0.74 g of Li₂CO₃, 1.6 g of ZnO, 13.1 g of Ga₂O₃, and 0.20 g of Cr₂O₃ (the target composition is LiZnGa₇O₁₂:Cr_{0.13}).
In the oxide phosphor according to Example 21, in Formula (1), the variable s is 0 (s=0), the element M² is Zn, the variable t is 1 (t=1), the variable u is 1 (u=1), the variable v is 0 (v=0), the variable w is 7 (w=7), the variable x is 12 (x=12), the variable y is 0.13 (y=0.13), and the variable z is 0 (z=0).

### Example 22

An oxide phosphor according to Example 22 having molar ratios similar to those of the target composition is obtained in the same manner as in Example 1, except that a raw material mixture is prepared by weighing raw materials to achieve 0.74 g of Li₂CO₃, 1.6 g of ZnO, 13.1 g of Ga₂O₃, and 0.31 g of Cr₂O₃ (the target composition is LiZnGa₇O₁₂:Cr_{0.20}).
In the oxide phosphor according to Example 22, in Formula (1), the variable s is 0 (s=0), the element M² is Zn, the variable t is 1 (t=1), the variable u is 1 (u=1), the variable v is 0 (v=0), the variable w is 7 (w=7), the variable x is 12 (x=12), the variable y is 0.20 (y=0.20), and the variable z is 0 (z=0).

### Example 23

An oxide phosphor according to Example 23 having molar ratios similar to those of the target composition is obtained in the same manner as in Example 1, except that a raw material mixture is prepared by weighing raw materials to achieve 0.74 g of Li₂CO₃, 1.6 g of ZnO, 13.1 g of Ga₂O₃, and 0.40 g of Cr₂O₃ (the target composition is LiZnGa₇O₁₂:Cr_{0.26}).
In the oxide phosphor according to Example 23, in Formula (1), the variable s is 0 (s=0), the element M² is Zn, the variable t is 1 (t=1), the variable u is 1 (u=1), the variable v is 0 (v=0), the variable w is 7 (w=7), the variable x is 12 (x=12), the variable y is 0.26 (y=0.26), and the variable z is 0 (z=0).

### Example 24

An oxide phosphor according to Example 24 having molar ratios similar to those of the target composition is obtained in the same manner as in Example 1, except that a raw material mixture is prepared by weighing raw materials to achieve 0.74 g of Li₂CO₃, 3.2 g of ZnO, 16.8 g of Ga₂O₃, and 0.20 g of Cr₂O₃ (the target composition is LiZn₂Ga₉O₁₆:Cr_{0.13}).
In the oxide phosphor according to Example 24, in Formula (1), the variable s is 0 (s=0), the element M² is Zn, the variable t is 1 (t=1), the variable u is 2 (u=2), the variable v is 0 (v=0), the variable w is 9 (w=9), the variable x is 16 (x=16), the variable y is 0.13 (y=0.13), and the variable z is 0 (z=0).

### Example 25

An oxide phosphor according to Example 25 having molar ratios similar to those of the target composition is obtained in the same manner as in Example 1, except that a raw material mixture is prepared by weighing raw materials to achieve 0.74 g of Li₂CO₃, 3.2 g of ZnO, 16.8 g of Ga₂O₃, and 0.31 g of Cr₂O₃ (the target composition is LiZn₂Ga₉O₁₆:Cr_{0.20}).
In the oxide phosphor according to Example 25, in Formula (1), the variable s is 0 (s=0), the element M² is Zn, the variable t is 1 (t=1), the variable u is 2 (u=2), the variable v is 0 (v=0), the variable w is 9 (w=9), the variable x is 16 (x=16), the variable y is 0.20 (y=0.20), and the variable z is 0 (z=0).

### Example 26

An oxide phosphor according to Example 26 having molar ratios similar to those of the target composition is obtained in the same manner as in Example 1, except that a raw material mixture is prepared by weighing raw materials to achieve 0.74 g of Li₂CO₃, 3.2 g of ZnO, 16.8 g of Ga₂O₃, and 0.40 g of Cr₂O₃ (the target composition is LiZn₂Ga₉O₁₆:Cr_{0.26}).
In the oxide phosphor according to Example 26, in Formula (1), the variable s is 0 (s=0), the element M² is Zn, the variable t is 1 (t=1), the variable u is 2 (u=2), the variable v is 0 (v=0), the variable w is 9 (w=9), the variable x is 16 (x=16), the variable y is 0.26 (y=0.26), and the variable z is 0 (z=0).

### Example 27

An oxide phosphor according to Example 27 having molar ratios similar to those of the target composition is obtained in the same manner as in Example 1, except that a raw material mixture is prepared by weighing raw materials to achieve 0.74 g of Li₂CO₃, 6.5 g of ZnO, 24.3 g of Ga₂O₃, and 0.20 g of Cr₂O₃ (the target composition is LiZn₄Ga₁₃O₂₄:Cr_{0.13}).
In the oxide phosphor according to Example 27, in Formula (1), the variable s is 0 (s=0), the element M² is Zn, the variable t is 1 (t=1), the variable u is 4 (u=4), the variable v is 0 (v=0), the variable w is 13 (w=13), the variable x is 24 (x=24), the variable y is 0.13 (y=0.13), and the variable z is 0 (z=0).

### Example 28

An oxide phosphor according to Example 28 having molar ratios similar to those of the target composition is obtained in the same manner as in Example 1, except that a raw material mixture is prepared by weighing raw materials to achieve 0.74 g of Li₂CO₃, 6.5 g of ZnO, 24.3 g of Ga₂O₃, and 0.31 g of Cr₂O₃ (the target composition is LiZn₄Ga₁₃O₂₄:Cr_{0.20}).
In the oxide phosphor according to Example 28, in Formula (1), the variable s is 0 (s=0), the element M² is Zn, the variable t is 1 (t=1), the variable u is 4 (u=4), the variable v is 0 (v=0), the variable w is 13 (w=13), the variable x is 24 (x=24), the variable y is 0.20 (y=0.20), and the variable z is 0 (z=0).

### Example 29

An oxide phosphor according to Example 29 having molar ratios similar to those of the target composition is obtained in the same manner as in Example 1, except that a raw material mixture is prepared by weighing raw materials to achieve 0.74 g of Li₂CO₃, 6.5 g of ZnO, 24.3 g of Ga₂O₃, and 0.40 g of Cr₂O₃ (the target composition is LiZn₄Ga₁₃O₂₄:Cr_{0.26}).
In the oxide phosphor according to Example 29, in Formula (1), the variable s is 0 (s=0), the element M² is Zn, the variable t is 1 (t=1), the variable u is 4 (u=4), the variable v is 0 (v=0), the variable w is 13 (w=13), the variable x is 24 (x=24), the variable y is 0.26 (y=0.26), and the variable z is 0 (z=0).

### Example 30

An oxide phosphor according to Example 30 having molar ratios similar to those of the target composition is obtained in the same manner as in Example 1, except that a raw material mixture is prepared by weighing raw materials to achieve 0.74 g of Li₂CO₃, 0.41 g of MgO, 0.80 g of ZnO, 13.1 g of Ga₂O₃, and 0.31 g of Cr₂O₃ (the target composition is LiMg_{0.5}Zn_{0.5}Ga₇O₁₂:Cr_{0.20}).
In the oxide phosphor according to Example 30, in Formula (1), the variable s is 0 (s=0), the element M² is Zn, the variable t is 0.5 (t=0.5), the variable u is 1 (u=1), the variable v is 0 (v=0), the variable w is 7 (w=7), the variable x is 12 (x=12), the variable y is 0.20 (y=0.20), and the variable z is 0 (z=0).

### Example 31

An oxide phosphor according to Example 31 having molar ratios similar to those of the target composition is obtained in the same manner as in Example 1, except that a raw material mixture is prepared by weighing raw materials to achieve 0.74 g of Li₂CO₃, 0.81 g of MgO, 1.6 g of ZnO, 16.8 g of Ga₂O₃, and 0.31 g of Cr₂O₃ (the target composition is Li(Mg_{0.5}Zn_{0.5})₂Ga₉O₁₆:Cr_{0.20}).
In the oxide phosphor according to Example 31, in Formula (1), the variable s is 0 (s=0), the element M² is Zn, the variable t is 0.5 (t=0.5), the variable u is 2 (u=2), the variable v is 0 (v=0), the variable w is 9 (w=9), the variable x is 16 (x=16), the variable y is 0.20 (y=0.20), and the variable z is 0 (z=0).

### Example 32

An oxide phosphor according to Example 32 having molar ratios similar to those of the target composition is obtained in the same manner as in Example 1, except that a raw material mixture is prepared by weighing raw materials to achieve 0.74 g of Li₂CO₃, 1.6 g of MgO, 3.2 g of ZnO, 24.3 g of Ga₂O₃, and 0.31 g of Cr₂O₃ (the target composition is Li(Mg_{0.5}Zn_{0.5})₄Ga₁₃O₂₄:Cr_{0.20}).
In the oxide phosphor according to Example 32, in Formula (1), the variable s is 0 (s=0), the element M² is Zn, the variable t is 0.5 (t=0.5), the variable u is 4 (u=4), the variable v is 0 (v=0), the variable w is 13 (w=13), the variable x is 24 (x=24), the variable y is 0.20 (y=0.20), and the variable z is 0 (z=0).

### Example 33

An oxide phosphor according to Example 33 having molar ratios similar to those of the target composition is obtained in the same manner as in Example 1, except that a raw material mixture is prepared by weighing raw materials to achieve 0.74 g of Li₂CO₃, 0.81 g of MgO, 13.1 g of Ga₂O_{3, 0.65} g of Cr₂O₃ and 0.07 g of NiO (the target composition is LiMgGa₇O₁₂:Cr_{0.42}, Ni_{0.05}).
In the oxide phosphor according to Example 33, in Formula (1), the variable s is 0 (s=0), the variable t is 0 (t=0), the variable u is 1 (u=1), the variable v is 0 (v=0), the variable w is 7 (w=7), the variable x is 12 (x=12), the variable y is 0.42 (y=0.42), the element M⁴ is Ni, and the variable z is 0.05 (z=0.05).

### Example 34

An oxide phosphor according to Example 34 having molar ratios similar to those of the target composition is obtained in the same manner as in Example 1, except that a raw material mixture is prepared by weighing raw materials to achieve 0.74 g of Li₂CO₃, 0.08 g of MgO, 9.7 g of Ga₂O₃, and 0.31 g of Cr₂O₃ (the target composition is LiMg_{0.1}Ga_{5.2}O_{8.4}:Cr_{0.20}).
In the oxide phosphor according to Example 34, in Formula (1), the variable s is 0 (s=0), the variable t is 0 (t=0), the variable u is 0.1 (u=0.1), the variable v is 0 (v=0), the variable w is 5.2 (w=5.2), the variable x is 8.4 (x=8.4), the variable y is 0.20 (y=0.20), and the variable z is 0 (z=0).

### Example 35

An oxide phosphor according to Example 35 having molar ratios similar to those of the target composition is obtained in the same manner as in Example 1, except that a raw material mixture is prepared by weighing raw materials to achieve 0.74 g of Li₂CO₃, 0.08 g of MgO, 9.7 g of Ga₂O₃, and 0.40 g of Cr₂O₃ (the target composition is LiMg_{0.1}Ga_{5.2}O_{8.4}:Cr_{0.26}).
In the oxide phosphor according to Example 35, in Formula (1), the variable s is 0 (s=0), the variable t is 0 (t=0), the variable u is 0.1 (u=0.1), the variable v is 0 (v=0), the variable w is 5.2 (w=5.2), the variable x is 8.4 (x=8.4), the variable y is 0.26 (y=0.26), and the variable z is 0 (z=0).

### Example 36

An oxide phosphor according to Example 36 having molar ratios similar to those of the target composition is obtained in the same manner as in Example 1, except that a raw material mixture is prepared by weighing raw materials to achieve 0.74 g of Li₂CO₃, 0.04 g of MgO, 9.5 g of Ga₂O₃, and 0.31 g of Cr₂O₃ (the target composition is LiMg_{0.5}Ga_{5.1}O_{8.2}:Cr_{0.20}).
In the oxide phosphor according to Example 36, in Formula (1), the variable s is 0 (s=0), the variable t is 0 (t=0), the variable u is 0.05 (u=0.05), the variable v is 0 (v=0), the variable w is 5.1 (w=5.1), the variable x is 8.2 (x=8.2), the variable y is 0.20 (y=0.20), and the variable z is 0 (z=0).

### Example 37

An oxide phosphor according to Example 37 having molar ratios similar to those of the target composition is obtained in the same manner as in Example 1, except that a raw material mixture is prepared by weighing raw materials to achieve 0.74 g of Li₂CO₃, 0.04 g of MgO, 9.5 g of Ga₂O₃, and 0.40 g of Cr₂O₃ (the target composition is LiMg_{0.05}Ga_{5.1}O_{8.2}:Cr_{0.26}).

In the oxide phosphor according to Example 37, in Formula (1), the variable s is 0 (s=0), the variable t is 0 (t=0), the variable u is 0.05 (u=0.05), the variable v is 0 (v=0), the variable w is 5.1 (w=5.1), the variable x is 8.2 (x=8.2), the variable y is 0.26 (y=0.26), and the variable z is 0 (z=0).

### Comparative Example 1

An oxide phosphor according to Comparative Example 1 having molar ratios similar to those of the target composition is obtained in the same manner as in Example 1, except that a raw material mixture is prepared by weighing raw materials to achieve 0.74 g of Li₂CO₃, 9.4 g of Ga₂O₃, and 0.26 g of Cr₂O₃ (the target composition is LiGa₅O₈:Cr_{0.17}).
The oxide phosphor according to Comparative Example 1 does not have the composition represented by Formula (1) and does not contain Mg or the element M² in the composition.
In the oxide phosphor according to Comparative Example 1, which has the composition represented by Formula (1a), in Formula (1a), a variable at is 0 (at =0), a variable au is 1 (au=1), a variable av is 0 (av=0), a variable aw is 8 (aw=8), a variable ax is 0.17 (ax=0.17), and a variable ay is 0 (ay=0).

### Comparative Example 2

An oxide phosphor according to Comparative Example 2 having molar ratios similar to those of the target composition is obtained in the same manner as in Example 1, except that a raw material mixture is prepared by weighing raw materials to achieve 2.0 g of MgO, 9.4 g of Ga₂O₃, and 0.68 g of Cr₂O₃ (the target composition is MgGa₂O₄:Cr_{0.18}). The oxide phosphor according to Comparative Example 2 does not have the composition represented by Formula (1) and does not contain Li in the composition. In the oxide phosphor according to Comparative Example 2, which has the composition represented by Formula (1b), in Formula (1b), bt is 0 (bt=0), bu is 1 (bu=1), by is 0 (bv=0), bw is 4 (bw=4), bx is 0.18 (bx=0.18), and by is 0 (bv=0).

### Comparative Example 3

An oxide phosphor according to Comparative Example 3 having molar ratios similar to those of the target composition is obtained in the same manner as in Example 1, except that a raw material mixture is prepared by weighing raw materials to achieve 4.9 g of ZnO, 11.2 g of Ga₂O₃, and 0.18 g of Cr₂O₃ (the target composition is ZnGa₂O₄:Cr_{0.4}). The oxide phosphor according to Comparative Example 3 does not have the composition represented by Formula (1) and does not contain Li in the composition. In the oxide phosphor according to Comparative Example 3, which has the composition represented by Formula (1b), in Formula (1b), the element M^{b1} is Zn, bt is 1 (bt=1), bu is 1 (bu=1), bv is 0 (bv=0), bw is 4 (bw=4), bx is 0.04 (bx=0.04), and by is 0 (by=0).

Measurement of Emission Spectrum, Light Emission Peak Wavelength, Full Width at Half Maximum (FWHM), and Relative Emission Intensity The emission spectrum of each of the oxide phosphors of the Examples and Comparative Examples was measured using a quantum efficiency measurement system (QE-2000, available from Otsuka Electronics Co., Ltd.). The light emission peak wavelength of the excitation light of the light-emitting element, which is a semiconductor element used in the quantum efficiency measurement system, is 450 nm. From the resultant emission spectrum of each phosphor, the relative emission intensity, the light emission peak wavelength, and the full width at half maximum were determined as light-emitting characteristics. That is, the light emission peak wavelength (nm) in the emission spectrum of each phosphor and the full width at half maximum (FWHM) (nm) of the emission spectrum at the light emission peak wavelength were determined. For the oxide phosphors according to Examples 1 to 37 and the oxide phosphors according to Comparative Examples 2 and 3, the relative emission intensity (%) was determined by taking the emission intensity at the light emission peak wavelength of the oxide phosphor according to Comparative Example 1 as 100%. The results are shown in the table. In addition, the emission spectra of the oxide phosphors in the Examples and Comparative Examples are illustrated in the respective drawings.

TABLE 1

| | | Light | Full width | Relative |
|---|---|---|---|---|
| | | emission peak | at half | emission |
| | | wavelength | maximum | intensity |
| | Composition | (nm) | (nm) | (%) |
| Example 1 | LiMg_{0.2}Ga_{5.4}O_{8.8}: Cr_{0.20} | 825 | 210 | 134 |
| Example 2 | LiMg_{0.2}Ga_{5.4}O_{8.8}: Cr_{0.26} | 830 | 200 | 136 |
| Example 3 | LiMg_{0.35}Ga_{5.7}O_{9.4}: Cr_{0.20} | 827 | 220 | 153 |
| Example 4 | LiMg_{0.35}Ga_{5.7}O_{9.4}: Cr_{0.26} | 833 | 205 | 156 |
| Example 5 | LiMg_{0.5}Ga₆O₁₀: Cr_{0.20} | 825 | 205 | 156 |
| Example 6 | LiMg_{0.5}Ga₆O₁₀: Cr_{0.26} | 826 | 210 | 159 |
| Example 7 | LiMg_{0.75}Ga_{6.5}O₁₁: Cr_{0.20} | 828 | 220 | 149 |
| Example 8 | LiMg_{0.75}Ga_{6.5}O₁₁: Cr_{0.26} | 835 | 210 | 156 |
| Example 9 | LiMgGa₇O₁₂: Cr_{0.04} | 720 | 35 | 131 |
| Example 10 | LiMgGa₇O₁₂: Cr_{0.13} | 720 | 195 | 149 |
| Example 11 | LiMgGa₇O₁₂: Cr_{0.20} | 826 | 210 | 135 |
| Example 12 | LiMgGa₇O₁₂: Cr_{0.26} | 838 | 215 | 154 |
| Example 13 | LiMgGa₇O₁₂: Cr_{0.33} | 859 | 210 | 149 |
| Example 14 | LiMgGa₇O₁₂: Cr_{0.40} | 843 | 210 | 121 |
| Example 15 | LiMgGa₇O₁₂: Cr_{0.46} | 883 | 195 | 80 |
| Example 16 | LiMg_{1.5}Ga₈O₁₄: Cr_{0.20} | 826 | 245 | 152 |
| Example 17 | LiMg_{1.5}Ga₈O₁₄: Cr_{0.26} | 845 | 225 | 141 |
| Example 18 | LiMg₂Ga₉O₁₆: Cr_{0.13} | 724 | 195 | 139 |
| Example 19 | LiMg₂Ga₉O₁₆: Cr_{0.26} | 846 | 210 | 133 |
| Example 20 | LiMg₄Ga₁₃O₂₄: Cr_{0.13} | 724 | 185 | 136 |
| Example 21 | LiZnGa₇O₁₂: Cr_{0.13} | 834 | 225 | 131 |
| Example 22 | LiZnGa₇O₁₂: Cr_{0.20} | 841 | 245 | 128 |
| Example 23 | LiZnGa₇O₁₂: Cr_{0.26} | 844 | 210 | 125 |
| Example 24 | LiZn₂Ga₉O₁₆: Cr_{0.13} | 756 | 225 | 125 |
| Example 25 | LiZn₂Ga₉O₁₆: Cr_{0.20} | 838 | 250 | 112 |
| Example 26 | LiZn₂Ga₉O₁₆: Cr_{0.26} | 851 | 210 | 105 |
| Example 27 | LiZn₄Ga₁₃O₂₄: Cr_{0.13} | 707 | 195 | 102 |
| Example 28 | LiZn₄Ga₁₃O₂₄: Cr_{0.20} | 825 | 260 | 106 |
| Example 29 | LiZn₄Ga₁₃O₂₄: Cr_{0.26} | 854 | 215 | 98 |
| Example 30 | Li(Mg_{0.5}Zn_{0.5})Ga₇O₁₂: Cr_{0.20} | 835 | 240 | 117 |
| Example 31 | Li(Mg_{0.5}Zn_{0.5})₂Ga₉O₁₆: Cr_{0.20} | 849 | 240 | 112 |
| Example 32 | Li(Mg_{0.5}Zn_{0.5})₄Ga₁₃O₂₄: Cr_{0.20} | 847 | 260 | 105 |
| Example 33 | LiMgGa₇O₁₂: Cr_{0.42}, Ni_{0.05} | 1248 | 185 | 87 |
| Example 34 | LiMg_{0.1}Ga_{5.2}O_{8.4}: Cr_{0.20} | 837 | 200 | 135 |
| Example 35 | LiMg_{0.1}Ga_{5.2}O_{8.4}: Cr_{0.26} | 830 | 200 | 143 |
| Example 36 | LiMg_{0.05}Ga_{5.1}O_{8.2}: Cr_{0.20} | 828 | 200 | 122 |
| Example 37 | LiMg_{0.05}Ga_{5.1}O_{8.2}: Cr_{0.26} | 831 | 195 | 116 |
| Comparative | LiGa₅O₈: Cr_{0.17} | 720 | 130 | 100 |
| Example 1 | | | | |
| Comparative | MgGa₂O₄: Cr_{0.18} | 884 | 185 | 109 |
| Example 2 | | | | |
| Comparative | ZnGa₂O₄: Cr_{0.04} | 715 | 80 | 71 |
| Example 3 | | | | |

The oxide phosphors according to Examples 1 to 37 have the composition represented by Formula (1), and can emit light having a light emission peak wavelength in a red to near-infrared wavelength range of 700 nm to 1500 nm in the emission spectrum upon irradiation with excitation light.

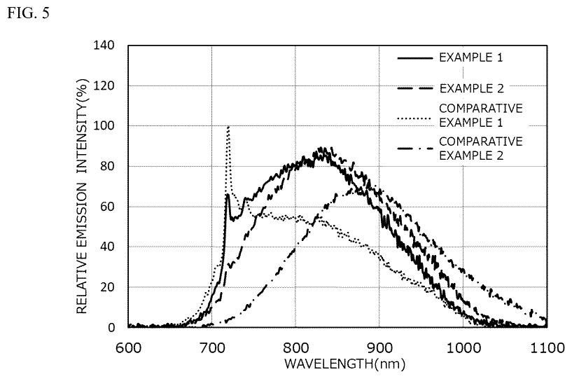

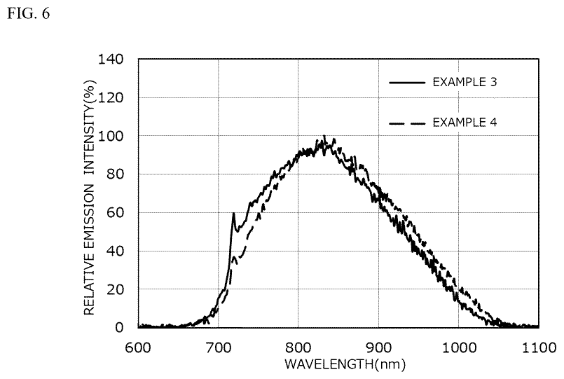

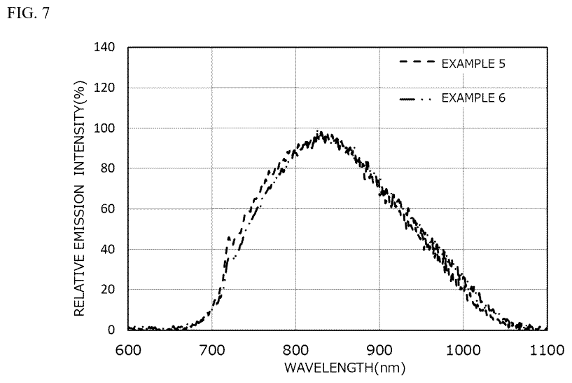

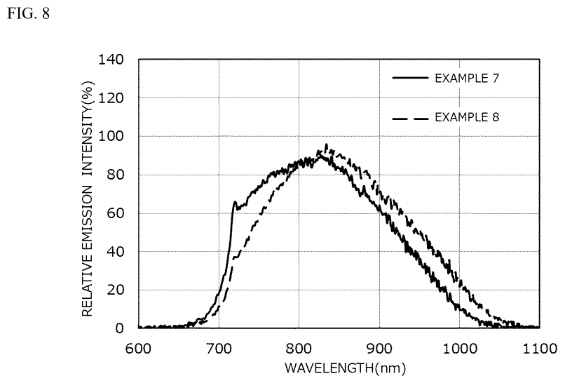

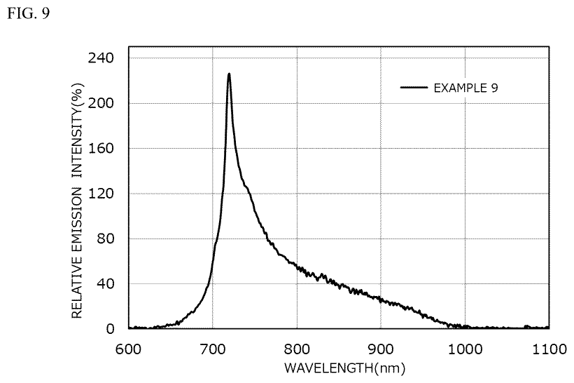

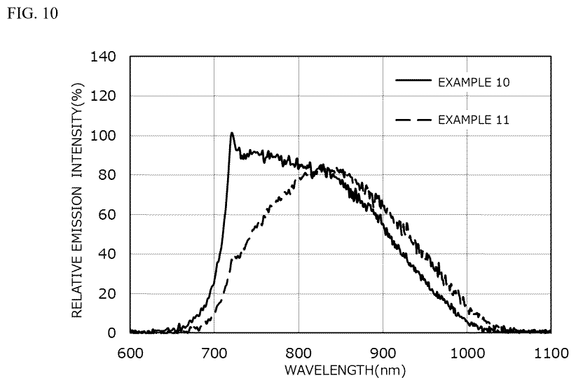

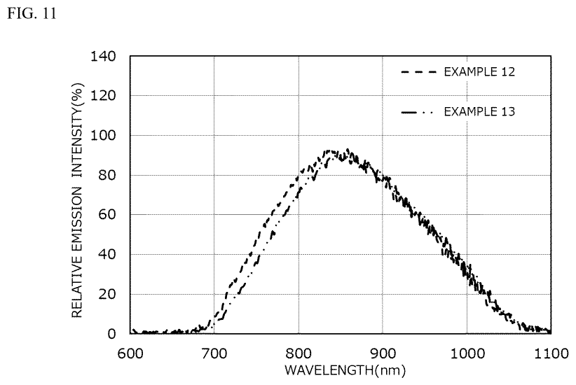

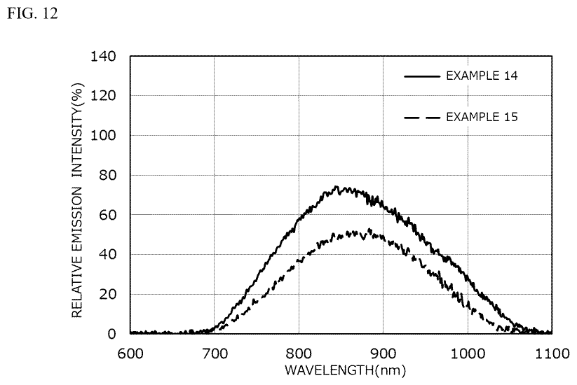

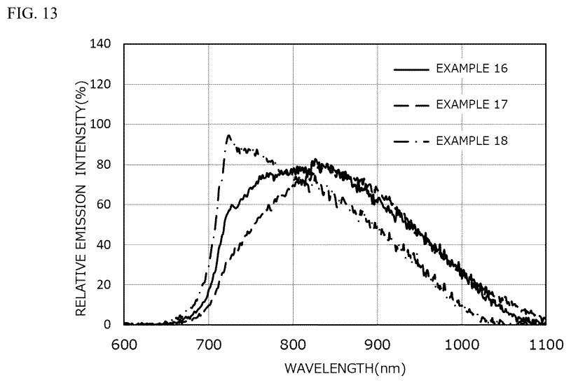

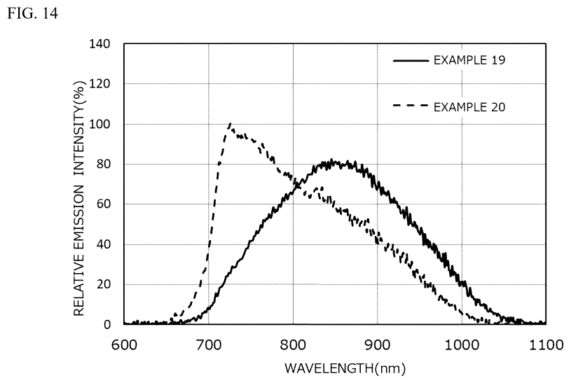

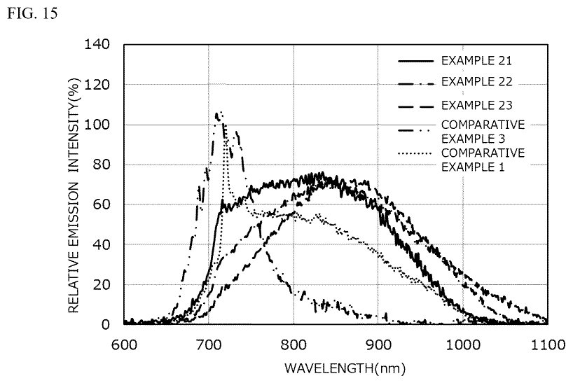

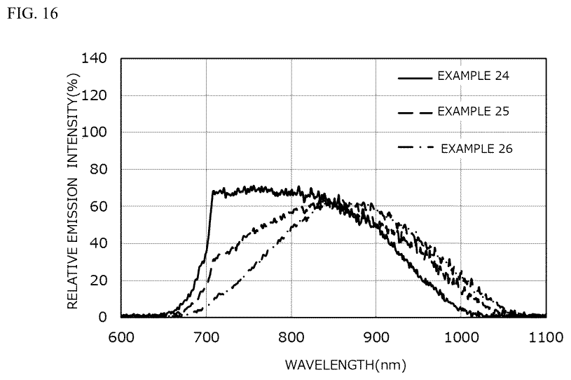

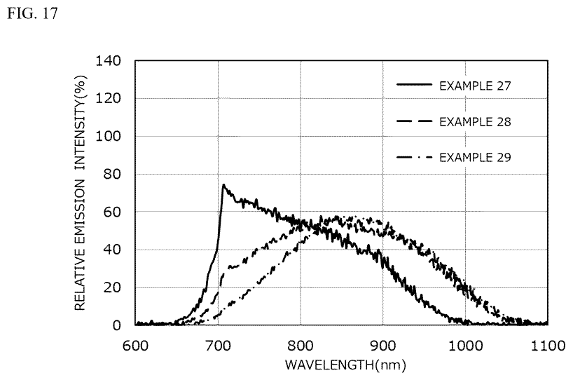

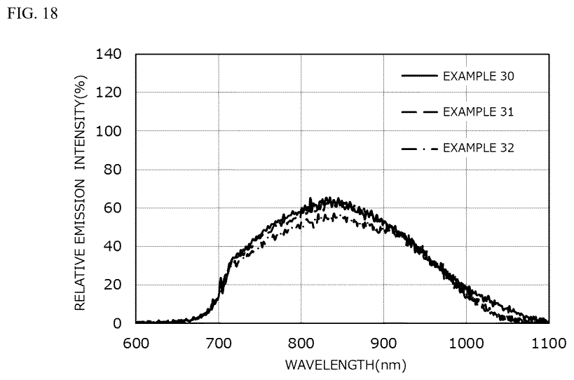

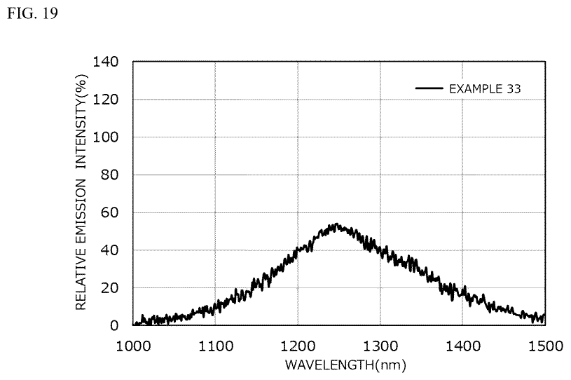

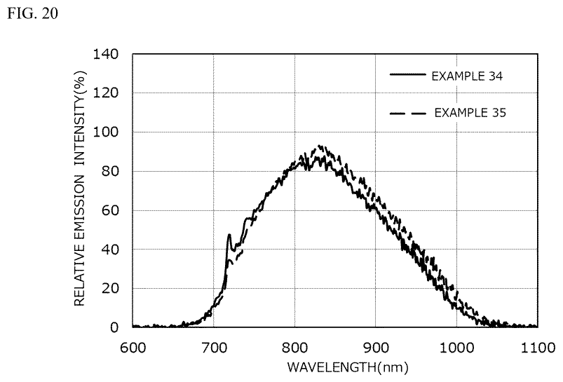

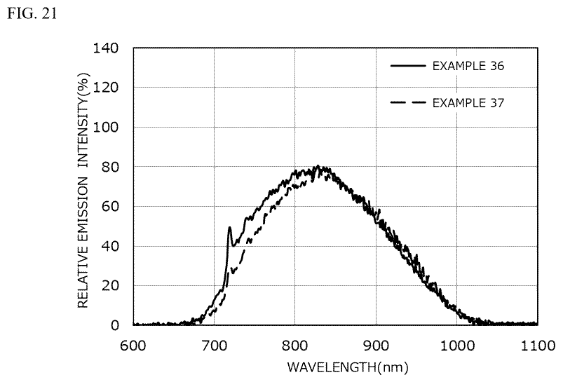

As illustrated in the emission spectrum of each of the oxide phosphors in FIGS. 5 to 21, the oxide phosphors according to Examples 1 to 37 emit light having a light emission peak wavelength in a red to near-infrared wavelength range of 700 nm to 1500 nm upon irradiation with excitation light.

The oxide phosphors according to Examples 1 to 8 and 10 to 37 emit light with an emission spectrum having a light emission peak wavelength and a full width at half maximum in a range of 150 nm to 280 nm upon irradiation with excitation light. It is preferable that light with a wide full width at half maximum be irradiated to obtain in vivo information such as subtle changes in the propagation behavior of light in blood within a living body, as well as the internal information on agricultural products, and fruits and vegetables. The oxide phosphors according to Examples 1 to 8 and 10 to 37 can emit light having an excellent color rendering property when a full width at half maximum is wide. In Example 9, in the composition represented by Formula (1), the molar ratio of Cr as an activating element is 0.04, and since the molar ratio of Cr is small, a full width at half maximum becomes less than 150 nm.

The oxide phosphor according to Comparative Example 1 has the composition represented by Formula (1a), and the oxide phosphors according to Comparative Examples 2 and 3 have the composition represented by Formula (1b).

The oxide phosphors according to Examples 1 to 14, 16 to 20, and 34 to 37 emit light with a higher emission intensity upon irradiation with excitation light as compared with the emission intensity obtained by dividing the sum of the emission intensity of the oxide phosphor according to Comparative Example 1 and the emission intensity of the oxide phosphor according to Comparative Example 2 by 2.

The oxide phosphors according to Examples 21 to 29 and 30 to 33 emit light with a higher emission intensity upon irradiation with excitation light as compared with the emission intensity obtained by dividing the sum of the emission intensity of the oxide phosphor according to Comparative Example 1 and the emission intensity of the oxide phosphor according to Comparative Example 3 by 2.

The oxide phosphors according to Examples 34 to 37, in the composition represented by Formula (1), emit light with a higher emission intensity upon irradiation with excitation light than the oxide phosphor according to Comparative Example 1 having the composition represented by Formula (1a) and the oxide phosphors according to Comparative Examples 2 and 3 having the composition represented by Formula (1b) even in a case in which 0.05 mol to 0.1 mol of the oxide phosphor having the composition represented by Formula (1b) is combined with respect to 1 mol of the oxide phosphor having the composition represented by Formula (1a).

In the oxide phosphor according to Example 15, the molar ratio of Cr as an activating element is as large as 0.46 in the composition represented by Formula (1), and the emission intensity is lower than that of the oxide phosphor according to Comparative Example 1 due to concentration quenching.

The oxide phosphor according to Example 29, in the composition represented by Formula (1), has Mg replaced with Zn, which serves as the element M², and is combined with 4 mol of the oxide phosphor having the composition represented by Formula (1b) with respect to 1 mol of the oxide phosphor having the composition represented by the formula (1a). It is presumed that the lattice length in the crystal structure is different on the Li side, the Mg side, and the Zn side and distortion occurs in the crystal structure. Upon irradiation with excitation light, the full width at half maximum in the emission spectrum increases to exceed 150 nm, but the emission intensity is slightly lower than that of the oxide phosphor according to Comparative Example 1.

The oxide phosphor according to Example 33, in the composition represented by Formula (1), has Ni as the element M⁴ serving as an activating agent along with Cr, and the light emission peak wavelength can be set to a long wavelength of 1248 nm. However, the emission intensity is slightly lower than that of the oxide phosphor according to Comparative Example 1.

The oxide phosphor according to Comparative Example 1 has the composition represented by Formula (1a), and the oxide phosphors according to Comparative Examples 2 and 3 have the composition represented by Formula (1b).

The oxide phosphor according to the present disclosure can also be used in a medical light-emitting device for obtaining in vivo information, a light-emitting device mounted on a small mobile device such as a smartphone or smartwatch for physical condition management, a light-emitting device used in a medical device, a light-emitting device for an analyzer for non-destructively measuring internal information of pharmaceutical products, or food products and agricultural products such as fruits, vegetables, and rice, a light-emitting device for plant cultivation that affects the photoreceptors of plants, and a light-emitting device of a reflection spectroscopic measurement device used to measure film thickness or the like.

What is claimed is:

1. An oxide phosphor having a composition represented by Formula (1) below: 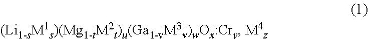
wherein in Formula (1), M¹ is at least one element selected from the group consisting of Na, K, Rb, and Cs; M² is at least one element selected from the group consisting of Ca, Sr, Ba, and Zn; M³ is at least one element selected from the group consisting of Al and Sc; M⁴ is at least one element selected from the group consisting of Ni, Ce, Eu, Fe, Mn, Nd, Tm, Ho, Er, and Yb; s, t, u, v, w, and x satisfy 0≤s≤0.5, 0≤t≤1.0, 0.03≤u≤10, 0≤v≤1.0, 5.1≤w≤25, 0.005≤u/w≤0.4, and 8.2≤x≤48; and when Li is taken as 1 or a total of Li and M¹ is taken as 1, y and z satisfy 0.02≤y≤0.5, 0≤z≤0.3, and y>z with respect to Li or to the total of Li and M¹, respectively.

2. The oxide phosphor according to claim 1, wherein
in Formula (1), when Li is taken as 1 or the total of Li and M¹ is taken as 1, y satisfies 0.03≤y≤0.48 with respect to Li or to the total of Li and M¹, respectively.

3. The oxide phosphor according to claim 1, wherein
in Formula (1), when Li is taken as 1 or the total of Li and M¹ is taken as 1, y satisfies 0.1≤y≤0.46 with respect to Li or to the total of Li and M¹, respectively.

4. The oxide phosphor according to claim 1, wherein
in Formula (1), t and u satisfy t=0 and 0.03≤u≤5.

5. The oxide phosphor according to claim 1, wherein
in Formula (1), t, u, and w satisfy t=0, 0.05≤u≤4, and 5.4≤w≤13.

6. The oxide phosphor according to claim 1, wherein
in Formula (1), s, t, u, and w satisfy s=0, t=0, 0.2≤u≤4, and 5.4≤w≤13.

7. The oxide phosphor according to claim 1, wherein
in Formula (1), M² is at least one element selected from the group consisting of Ca, Sr, and Ba, and t satisfies 0.01≤t≤0.3.

8. The oxide phosphor according to claim 1, wherein
the oxide phosphor emits light having a light emission peak wavelength in a range of 700 nm to 1500 nm in an emission spectrum upon irradiation with excitation light.

9. The oxide phosphor according to claim 1, wherein
the oxide phosphor emits light having a full width at half maximum in a range of 150 nm to 280 nm in an emission spectrum upon irradiation with excitation light.

10. The oxide phosphor according to claim 1, wherein
in Formula (1), M⁴ is Ni, and when Li is taken as 1, z satisfies 0.001≤z≤0.2.

11. The oxide phosphor according to claim 1, wherein
in Formula (1), t and u satisfy 0.4≤t≤0.6 and 0.2≤u≤5.

12. The oxide phosphor according to claim 11, wherein
the oxide phosphor emits light having a light emission peak wavelength in a range of 820 nm to 860 nm in an emission spectrum upon irradiation with excitation light.

13. The oxide phosphor according to claim 11, wherein
the oxide phosphor emits light having a full width at half maximum in a range of 200 nm to 280 nm in an emission spectrum upon irradiation with excitation light.

14. The oxide phosphor according to claim 1, wherein
in Formula (1), M² contains Zn, and t satisfies t=1.0.

15. The oxide phosphor according to claim 1, wherein
M² is Zn and t satisfies t=1.0 in Formula (1), and the oxide phosphor has a light emission peak wavelength in a range of 700 nm to 860 nm in an emission spectrum.

16. A light-emitting device comprising:
the oxide phosphor according to claim 1; and
a light-emitting element configured to emit light having a light emission peak wavelength in a range of 365 nm to 650 nm.
